(19) United States
(12) Patent Application Publication
(10) Pub. No.: US 2026/0192733 A1
(43) Pub. Date: Jul. 9, 2026

(54) EXPANDABLE MECHANICAL STRUCTURE FOR MOBILE LIVING UNITS

(71) Applicant: A&C FUTURE, INC., Irvine, CA (US)

(72) Inventors: Shoue Chen, Irvine, CA (US); Nicholas Sampson, Palos Verdes Estates, CA (US); James Robinson, Gardena, CA (US); Matthew Tindall, Long Beach, CA (US)

(21) Appl. No.: 19/404,810

(22) Filed: Dec. 1, 2025

Related U.S. Application Data
(60) Provisional application No. 63/742,091, filed on Jan. 6, 2025.

(51) Int. Cl. B60P 3/34

(52) U.S. Cl. CPC B60P 3/34

(57) ABSTRACT

A mobile living unit is designed to optimize living space through an innovative expandable mechanical structure. The system features modular and automated mechanisms, including an active hinge, that enable seamless transitions between a compact transport mode and an expansive living mode, ensuring structural stability and user convenience. A mechanical structure for mobile living units features expandable panels, synchronized actuators and modular designs. The system facilitates efficient transitions between compact and expanded configurations, ensuring stability, durability and ease of use. This general framework supports further innovations in rear and side extensional spaces, adaptable floor systems, and chassis subframes for advanced mobile living solutions.

### CROSS-REFERENCE TO RELATED APPLICATIONS

This application claims the benefit of priority of U.S. provisional patent application No. 63/742,091, filed Jan. 6, 2025, the contents of which are herein incorporated by reference.

### BACKGROUND OF THE INVENTION

### 1. Field of the Invention

Embodiments of the invention relate generally to mobile living units. More particularly, embodiments of the invention relate to a mobile living unit designed to optimize living space through an innovative expandable mechanical structure.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Traditional recreational vehicles (RVs) often struggle to balance space utilization with portability. Expandable structures can provide significant improvements, but existing designs are frequently limited by complexity, mechanical inefficiencies, or lack of durability.

With the resurgence of outdoor activities, RV trips have become an increasingly popular way to spend quality family time, embark on new adventures, and immerse in the beauty of nature. However, conventional RVs, trailers, and teardrop trailers often suffer from a critical limitation: restricted living space. For families, this limitation can result in cramped interiors that compromise comfort, freedom of movement, and overall enjoyment.

Class A RVs, while offering a more home-like experience, come with their own set of challenges. Their larger size requires specialized driving licenses, expansive parking spaces (both at home and in public areas), and they are notoriously difficult to maneuver—especially in urban settings or remote locations with limited access.

In view of the foregoing, there is a need for an expandable mobile living unit that provides a reliable solution for enhanced spatial functionality.

### SUMMARY OF THE INVENTION

Embodiments of the present invention aim to solve the aforementioned problems in conventional mobile living units, such as RVs, by providing a streamlined and robust expandable mechanical system that addresses the challenges found in conventional structures, offering a reliable solution for enhanced spatial functionality. Embodiments of the present invention further lays the groundwork for specific modular extensions and adaptable floor and chassis systems.

To address these challenges, aspects of the present invention provide the innovative expandable RV structure—a revolutionary solution that combines the advantages of compact and spacious RVs. During travel, the RV maintains a Class C size, ensuring it drives like a regular van. Such a size would be less than 102 inches in width, ensuring legal travel on roadways, and would have a length less than 35 feet, typically less than 30 feet, and often less than 28 feet. This compact form allows seamless navigation through cities, towns, and tight roads while eliminating the need for specialized driving licenses or oversized parking accommodations. However, once parked at a campsite, the expandable structure transforms the RV, doubling or even tripling the living space. This expansion offers a level of comfort and luxury comparable to Class A RVs, providing ample room for families to relax, cook, sleep, and enjoy the outdoors.

By combining the maneuverability of Class C RVs with the spaciousness of Class A designs, the expandable RV redefines outdoor living. It delivers the perfect balance of convenience, versatility, and functionality—making it the ideal choice for families and adventure seekers alike.

Embodiments of the present invention provide an active hinge for hingedly connecting a first member with a second member, comprising a fixed bracket attached to the first member, wherein the first member is fixed relative to a structure; a movable bracket attached to the second member, wherein the second member is movable relative to the first member; a movable arm driven by a driving device; an angular motion device attached to the movable arm; and a fixed member having an outer surface upon which the angular motion device travels during movement of the movable arm, wherein when the movable arm is extended, the angular motion device moves to move the movable bracket into a retracted position, where the first member is disposed adjacent the second member; and when the movable arm is retracted, the angular motion device moves to move the movable bracket into an extended position, where the first member is disposed adjacent the second member to form a continuous surface.

In some embodiments, the driving device is a hydraulic driving device.

In some embodiments, the hydraulic driving device has a first hydraulic connection for actively extending the movable arm and a second hydraulic connection for actively retracting the movable arm.

In some embodiments, the angular motion device includes a first angular motion device disposed adjacent to and offset from a second angular motion device, wherein the first and second angular motion devices permit rotation of the hinge about an angle of 180 degrees.

In some embodiments, the first angular motion device slides along a slot formed in the fixed bracket.

In some embodiments, the first member is a first wall panel of an expansion section of a recreational vehicle and the second member is a second wall panel of the expansion section of the recreational vehicle.

In some embodiments, the first wall panel is stored adjacent the second wall panel when the movable arm is extended.

In some embodiments, retraction of the movable arm moves the first wall panel alongside the second wall panel to form a continuous wall surface, while assisting in the expansion of the expansion section of the recreational vehicle.

In some embodiments, the first member is a primary floor panel, and the second member is a secondary floor panel.

In some embodiments, the primary floor panel is stored adjacent the secondary floor panel when the movable arm is extended.

In some embodiments, retraction of the movable arm moves the secondary floor panel alongside the primary floor panel to form a continuous floor surface, while assisting in the expansion of the expansion section of the recreational vehicle.

Embodiments of the present invention provide a recreational vehicle having at least one expansion section utilizing an active hinge for expansion and retraction thereof, the active hinge comprising a fixed bracket attached to the first member, wherein the first member is fixed relative to a structure; a movable bracket attached to the second member, wherein the second member is movable relative to the first member; a movable arm driven by a driving device; an angular motion device attached to the movable arm; and a fixed member having an outer surface upon which the angular motion device travels during movement of the movable arm, wherein when the movable arm is extended, the angular motion device moves to move the movable bracket into a retracted position, where the first member is disposed adjacent the second member; and when the movable arm is retracted, the angular motion device moves to move the movable bracket into an extended position, where the first member is disposed adjacent the second member to form a continuous surface.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a front driver's side perspective view of an RV in a closed (mobile) configuration;

FIG. 2 illustrates a front passenger's side perspective view of the RV of FIG. 1, in a closed configuration;

FIG. 3 illustrates a rear driver's side perspective view of the RV of FIG. 1, in a closed configuration;

FIG. 4 illustrates a rear passenger's side perspective view of the RV of FIG. 1, in a closed configuration;

FIG. 5 illustrates a front driver's side perspective view of the RV of FIG. 1, in an open (parked or use) configuration;

FIG. 6 illustrates a front passenger's side perspective view of the RV of FIG. 1, in an open configuration;

FIG. 7 illustrates a rear driver's side perspective view of the RV of FIG. 1, in an open configuration;

FIG. 8 illustrates a rear passenger's side perspective view of the RV of FIG. 1, in an open configuration;

FIG. 9 illustrates a cross-sectional schematic front view of the RV of FIG. 1, in the closed configuration, where dimensions are provided (in inches) only as one example of an embodiment of the present invention;

FIG. 10 illustrates a cross-sectional schematic front view of the RV of FIG. 1, in the open configuration, where dimensions are provided (in inches) only as one example of an embodiment of the present invention;

FIG. 11 illustrates a cross-sectional schematic side view of the RV of FIG. 1, in the closed configuration, where dimensions are provided (in inches) only as one example of an embodiment of the present invention;

FIG. 12 illustrates a cross-sectional schematic side view of the RV of FIG. 1, in the open configuration, where dimensions are provided (in inches) only as one example of an embodiment of the present invention;

FIG. 13 illustrates a top view of the RV of FIG. 1, in the closed configuration;

FIG. 14 illustrates a cross-sectional schematic top view of the RV of FIG. 1, in the closed configuration, where dimensions are provided (in inches) only as one example of an embodiment of the present invention;

FIG. 15 illustrates a cross-sectional schematic top view of the RV of FIG. 1, in the open configuration, where dimensions are provided (in inches) only as one example of an embodiment of the present invention;

FIG. 16 illustrates a plan view of an exemplary floor usage/layout of the RV of FIG. 1, in the open configuration, where dimensions (section areas) are provided (in inches) only as one example of an embodiment of the present invention;

FIG. 17 illustrates a driver's side perspective view of the RV of FIG. 1, in a closed configuration;

FIG. 18 illustrates a detailed view taken along the arrows of FIG. 17, in the closed configuration;

FIG. 19 illustrates a detailed view taken along the arrows of FIG. 17, in the open configuration;

FIG. 20 illustrates an exploded perspective view of an expansion section of the RV of FIG. 1;

FIG. 21 illustrates a perspective view of the expansion section of FIG. 20, in the closed configuration;

FIG. 22 illustrates a perspective view of the expansion section of FIG. 20, in the open configuration;

FIG. 23 illustrates an exploded view of a floor system of the expansion section of the RV of FIG. 1;

FIG. 24 illustrates an assembled view of the floor system of FIG. 23;

FIG. 25 illustrates a component view of a rotational arm extension system of the RV of FIG. 1;

FIG. 26 illustrates the extension arms of the system of FIG. 25, in a retracted (closed) configuration;

FIG. 27 illustrates the extension arms of the system of FIG. 25, in an expanded (open) configuration;

FIG. 28 illustrates an exploded perspective view of the components of the rotational arm extension system of the RV of FIG. 1;

FIG. 29 illustrates an exploded perspective view of the components of the rotational arm extension system of FIG. 28, focusing on the extension motor unit;

FIG. 30 illustrates an exploded perspective view of the components of the rotational arm extension system of FIG. 28, focusing on the inner extension arm unit;

FIG. 31 illustrates an exploded perspective view of the components of the rotational arm extension system of FIG. 28, focusing on the outer extension arm unit;

FIGS. 32A and 32B illustrate a perspective and top views of the rotational arm extension system of FIG. 28 in the expanded (open) configuration;

FIG. 33 illustrates a perspective, top and detailed top views of the rotational arm extension system of FIG. 28 in the retracted (closed) configuration;

FIG. 34 illustrates a top perspective cross-sectional schematic view of the rear expansion section of the RV of FIG. 1, in the closed configuration;

FIG. 35 illustrates a side perspective view of the rear expansion section of the RV of FIG. 1, in the open configuration;

FIG. 36 illustrates a partial perspective view of the rear expansion section of the RV of FIG. 1, focusing on the frame and jack member;

FIG. 37 illustrates a detailed view taken about the circle of FIG. 36;

FIG. 38 illustrates a partial perspective view of the rear expansion section of the RV of FIG. 1, focusing on the frame and upper slider;

FIG. 39 illustrates a detailed view taken about the circle of FIG. 38;

FIG. 40 illustrates a perspective view of the upper slider with the cover off;

FIG. 41 illustrates a partial perspective view of the rear expansion section of the RV of FIG. 1, focusing on the I-beam extend mechanism;

FIG. 42 illustrates a detailed view taken about the circle of FIG. 41;

FIG. 43 illustrates a perspective view of the I-beam extend mechanism of FIG. 41;

FIG. 44 illustrates a top view of the I-beam extend mechanism of FIG. 43;

FIG. 45 illustrates a front view of the I-beam extend mechanism of FIG. 43;

FIG. 46 illustrates a front perspective view of the I-beam extend mechanism of FIG. 43;

FIG. 47 illustrates a rear perspective view of the I-beam extend mechanism of FIG. 43;

FIG. 48 illustrates a front view of the I-beam extend mechanism of FIG. 43, highlighting the roller bearing therein;

FIG. 49 illustrates a perspective view of the I-beam extend mechanism of FIG. 43, highlighting the roller bearing therein;

FIG. 50 illustrates a perspective view of an active hinge used in the RV of FIG. 1, in an opened (extended) state;

FIG. 51 illustrates a perspective view of the active hinge of FIG. 50, in a closed (folded) state;

FIG. 52 illustrates a cross-sectional view of the active hinge of FIG. 50, in the opened state;

FIG. 53 illustrates a cross-sectional view of the active hinge of FIG. 50 in a partially closed state;

FIG. 54 illustrates a perspective view of the active hinge of FIG. 50 beginning a transformation from the opened state toward the closed state;

FIG. 55 illustrates a perspective view of the active hinge of FIG. 54, at a half-way position between the opened and closed states;

FIG. 56 illustrates a perspective view of the active hinge of FIG. 54 in a completely closed state;

FIG. 57 illustrates a perspective view of a wall member where the active hinges of FIG. 50 are disposed;

FIG. 58 illustrates an exploded perspective view of the active hinge of FIG. 50; and

FIG. 59 illustrates the active hinge of FIG. 58 in an assembled configuration.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a mobile living unit designed to optimize living space through an innovative expandable mechanical structure. The system features modular and automated mechanisms that enable seamless transitions between a compact transport mode and an expansive living mode, ensuring structural stability and user convenience. A mechanical structure for mobile living units features expandable panels, synchronized actuators and modular designs. The system facilitates efficient transitions between compact and expanded configurations, ensuring stability, durability and ease of use. This general framework supports further innovations in rear and side extensional spaces, adaptable floor systems, and chassis subframes for advanced mobile living solutions.

Embodiments of the present invention are briefly described below, followed by a broader discussion of each figure and the components therein.

Embodiments of the present invention includes an expandable mechanical structure, automated deployment system, and structural integrity and stability features. The expandable mechanical structure includes modular panels for walls, roof and floor that fold or slide to increase living space. The mechanisms include telescopic rods, synchronized actuators and reinforced locking hinges.

The automated deployment system includes integrated actuators with a control interface enabling automated expansion and retraction. Safety features include load sensors and interlocking mechanisms.

The structural integrity and stability features include high-strength materials for load-bearing components and weatherproof seals and reinforced joints for durability. This general design framework provides a scalable foundation for subsequent innovations in extensional spaces, floor systems, and adaptable subframes.

The mechanical structure design can include modular panels, including the roof, sidewalls, and floor panels, that are designed to fold outward or slide along guided tracks. The panels are constructed using lightweight, high-strength materials such as aluminum alloys or composites. Telescopic rods provide linear motion for panel deployment and can be integrated with locking mechanisms to secure panels in place during use. Guided tracks can enable smooth sliding of the panels and can include stoppers to prevent overextension.

A rotational arm extension system can be located on the left side of the structure, this system uses pivoting arms to extend modular panels outward. This system includes reinforced hinges and automated locking mechanisms for stability.

A rack and pinion I-beam slide-out system can be positioned at the rear, where this system uses a rack-and-pinion mechanism integrated with I-beam tracks to provide precise and durable panel extension. The design ensures load distribution and smooth operation during deployment.

The deployment mechanism includes synchronized actuators which can be electrically powered actuators which drive the telescopic rods and guided tracks to ensure uniform movement across all expandable sections. A control interface provides a user-friendly control panel or mobile app interface for initiating expansion and retraction. Safety locks are provided to prevent unintended operation. A manual override can include a hand-operated mechanisms for manual expansion or retraction in case of power failure.

The structural integrity features can include load-bearing components, such as hinges and joints that are designed to withstand dynamic and static loads, reinforcements at stress points to enhance durability, weatherproofing, such as rubber seals along edges of panels to prevent water and air infiltration, and protective coatings to resist corrosion and wear.

The safety features can include load sensors to monitor mechanical loads during deployment to avoid overextension and to automatically halt operation if excessive load is detected, and interlocking mechanisms to secure panels in place once fully extended, thus preventing accidental retraction during use.

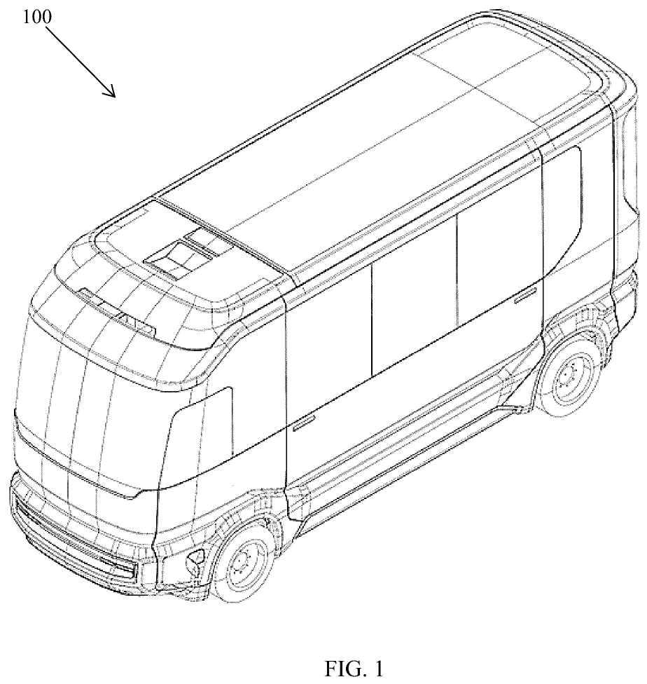

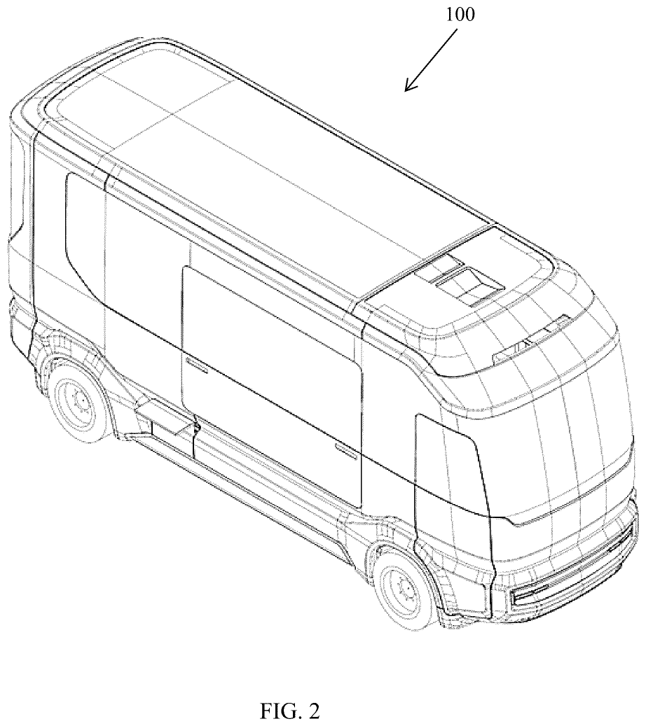

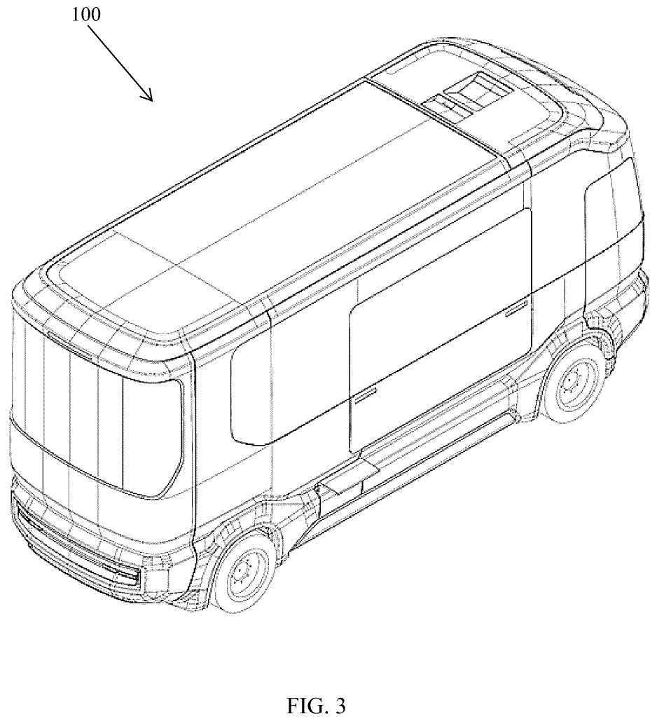

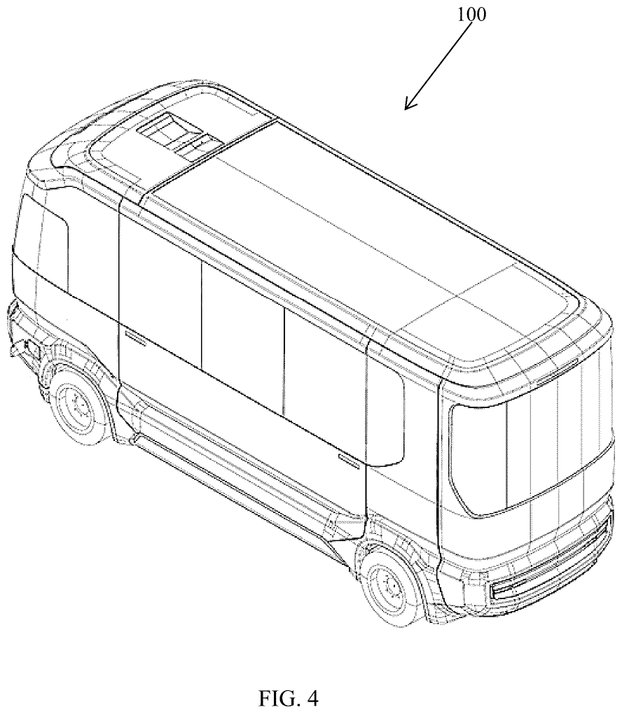

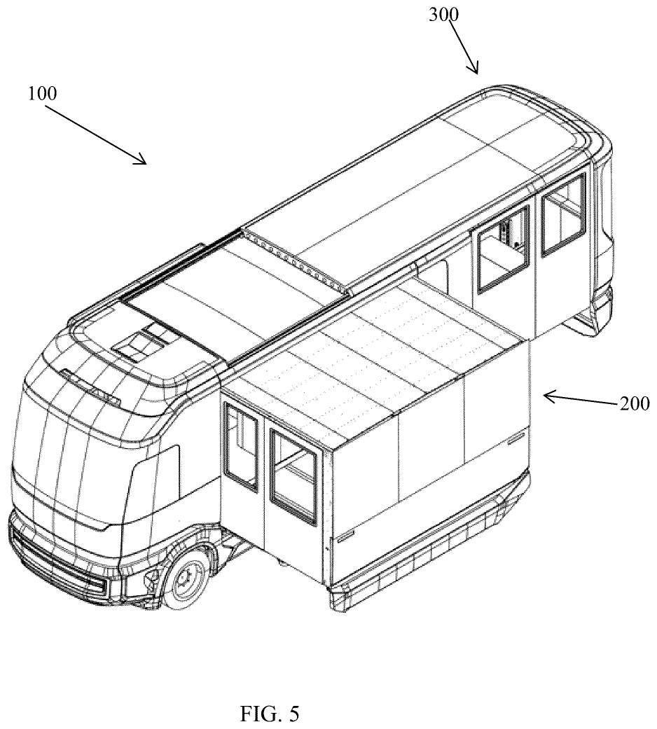

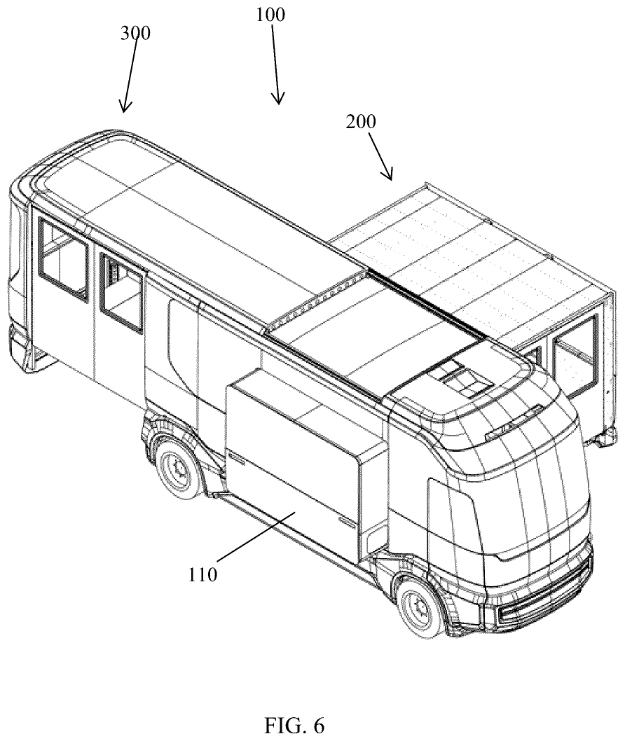

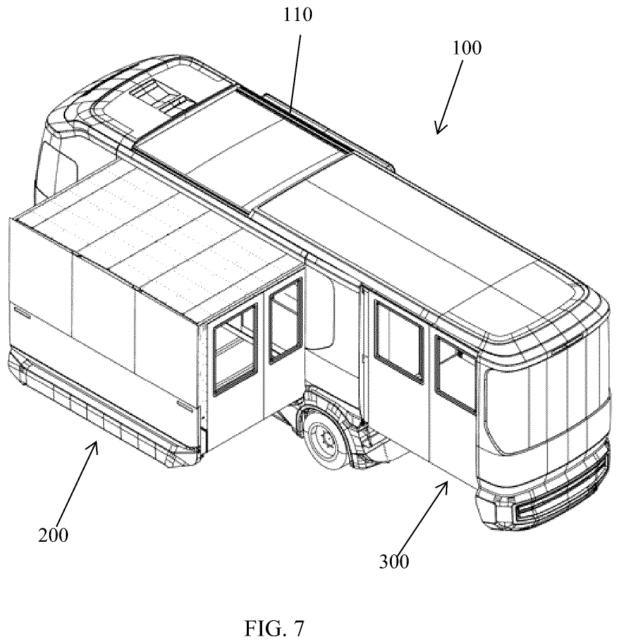

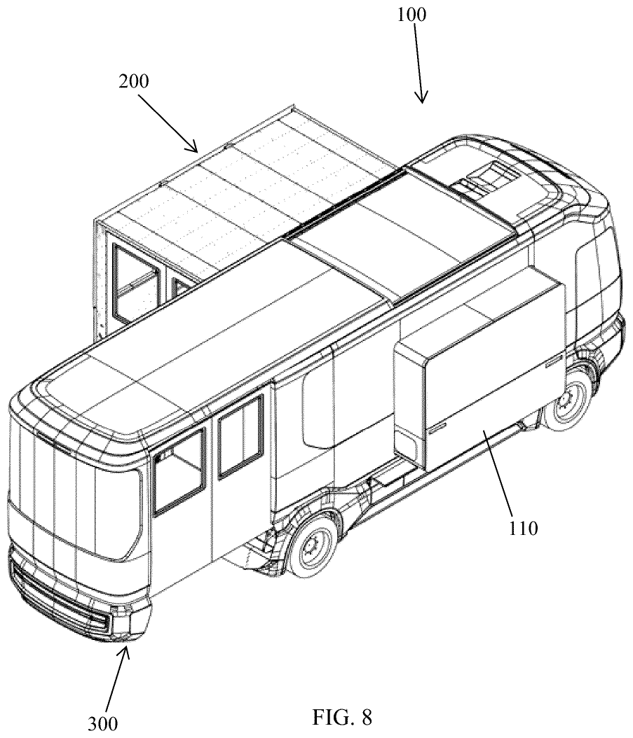

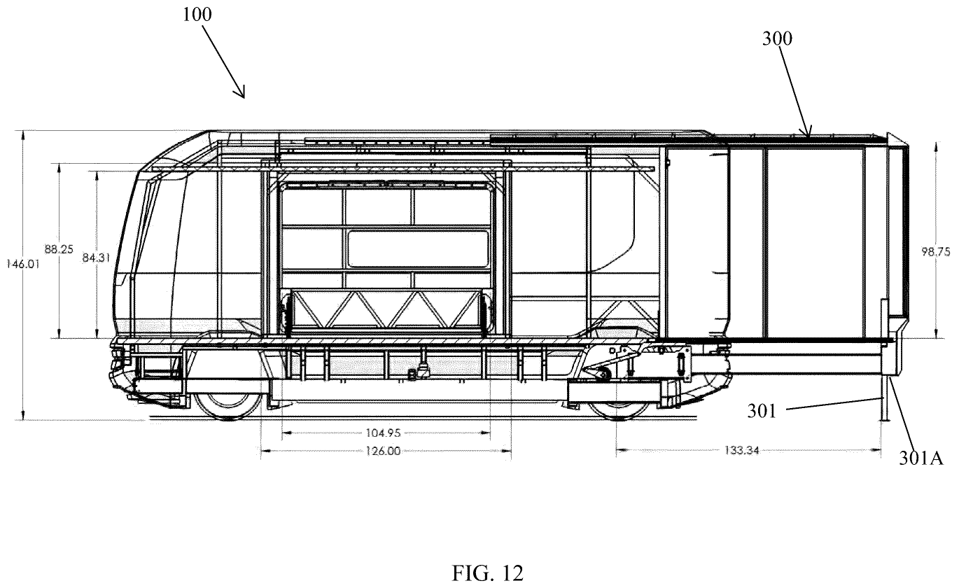

Referring to FIGS. 1 through 8, a mobile living unit 100 (also referred to as recreational vehicle 100 or RV 100) can include a conventional smaller slide out 110, such as a kitchen unit slide out, or the like. This slide out 110 may be disposed on the passenger's side, as illustrated. Of course, the positions of the slide out 110 may be exchanged with the position of the expansion section 200 (as described in greater detail below), such that the slide out 110 is on the driver's side and the expansion section 200 is on the passenger's side. The RV can further include a rear expansion section 300 (as described in greater detail below). The RV can travel in a direction of travel as is the case with conventional RVs, where the direction of travel is from right to left in the image of FIG. 12, for example.

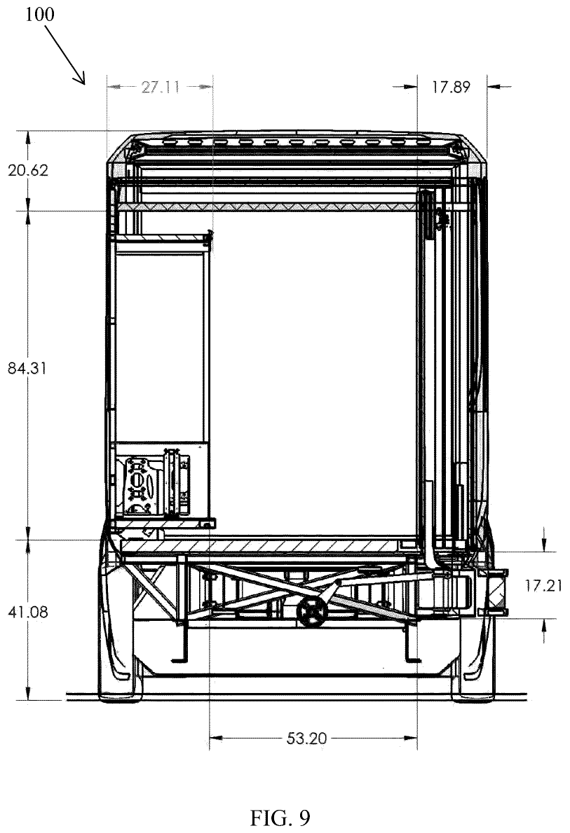

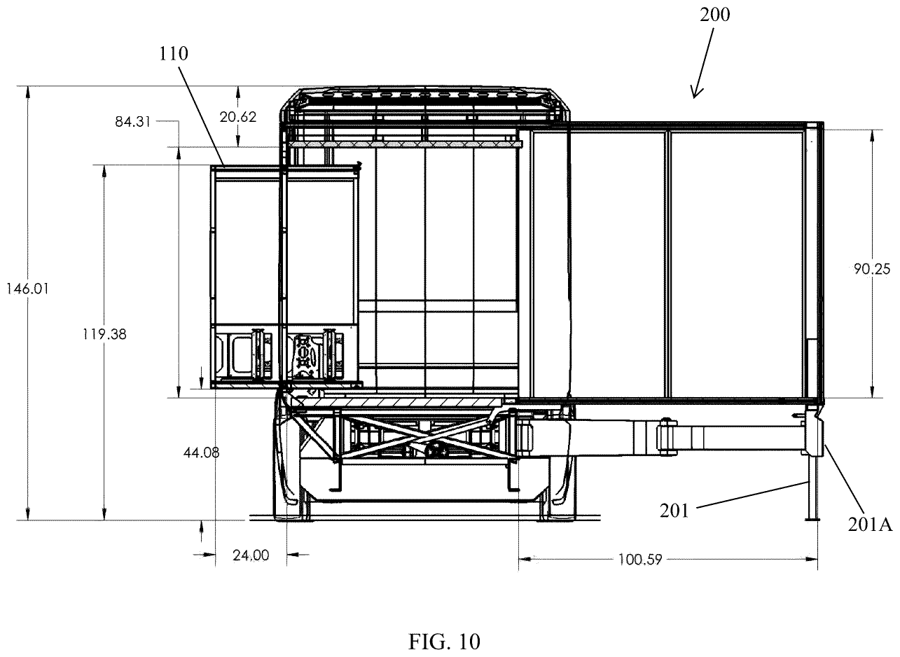

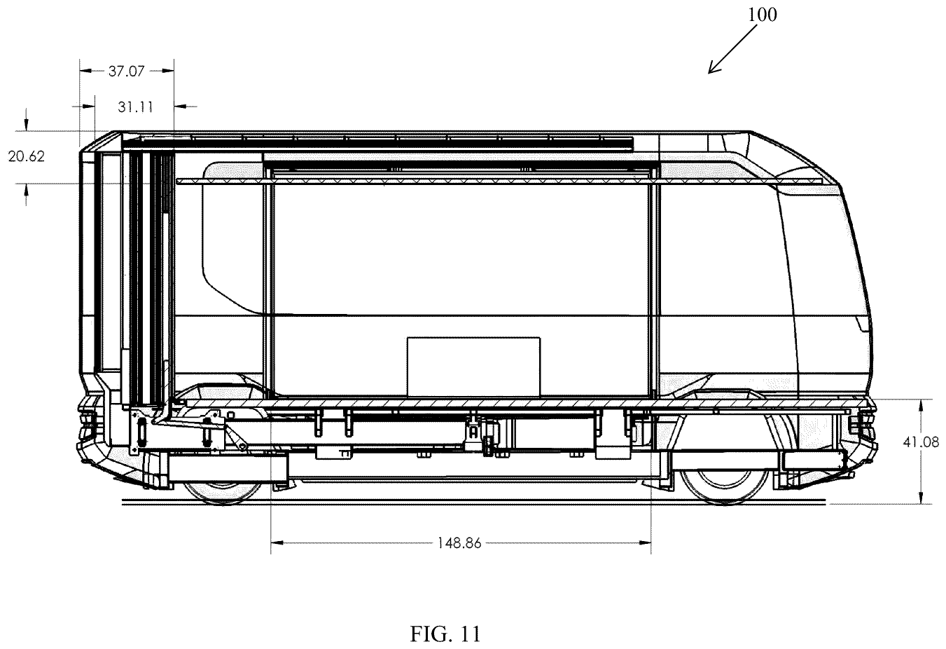

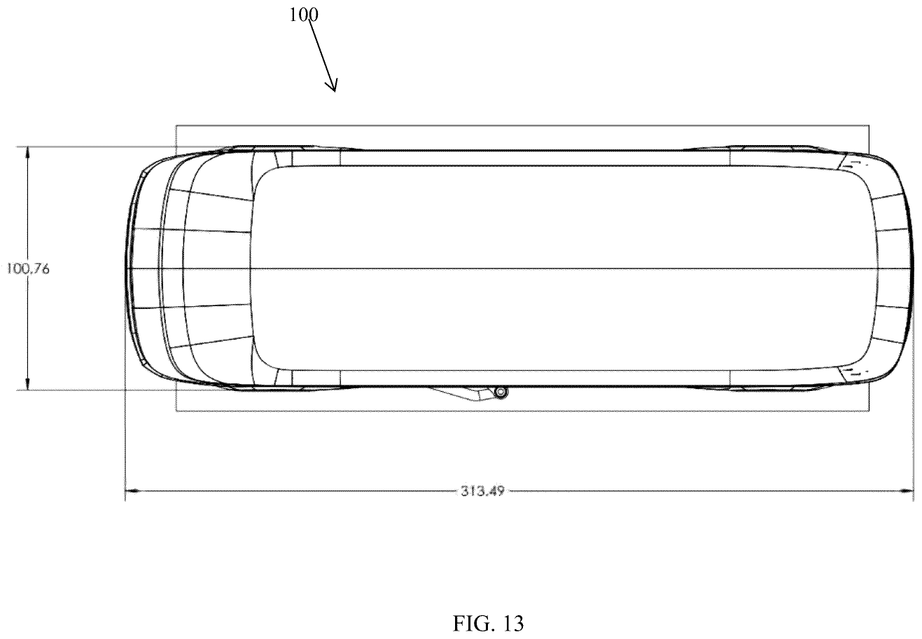

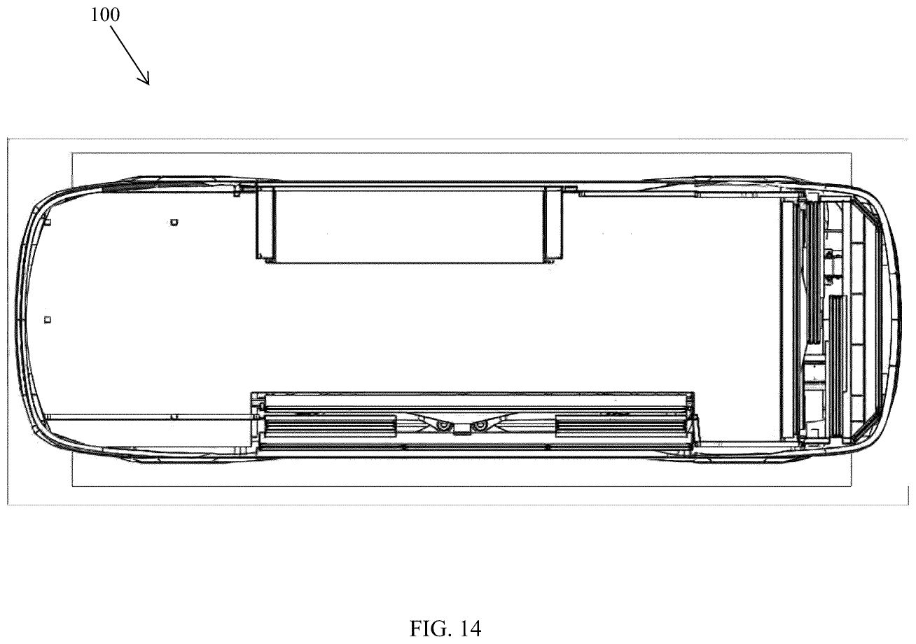

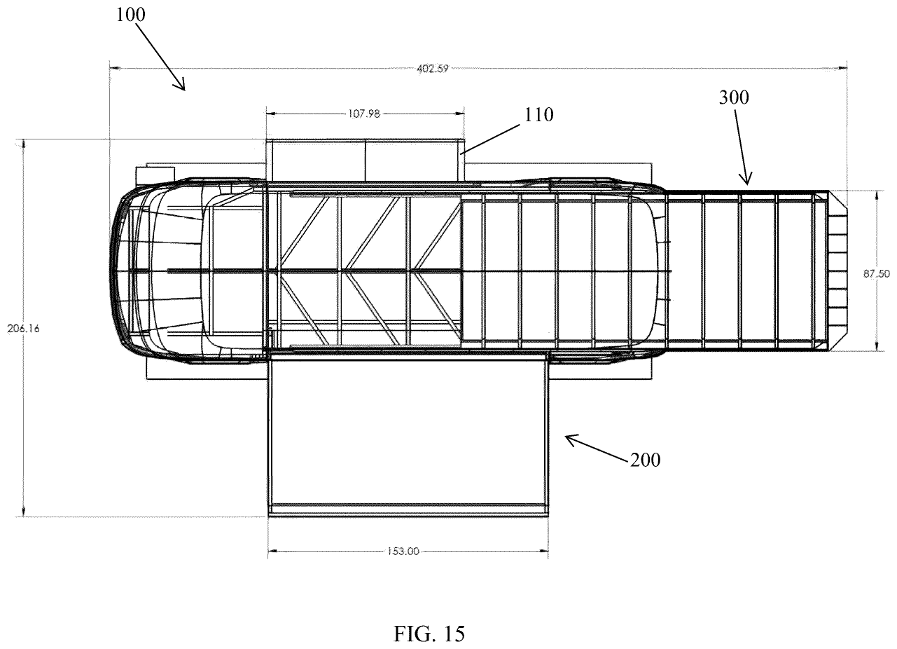

Referring to FIG. 9, a cross-sectional schematic front view of the RV 100 of FIG. 1, in the closed configuration is shown, where dimensions are provided (in inches) only as one example of an embodiment of the present invention. FIG. 10 shows a cross-sectional schematic front view of the RV 100 of FIG. 1, in the open configuration, where dimensions are provided (in inches) only as one example of an embodiment of the present invention. In FIG. 10, a side expansion section 200 is shown supported by support arm 201 that may be deployed from arm deployment structure 201A. FIG. 11 shows a cross-sectional schematic side view of the RV 100 of FIG. 1, in the closed configuration, where dimensions are provided (in inches) only as one example of an embodiment of the present invention. FIG. 12 shows a cross-sectional schematic side view of the RV 100 of FIG. 1, in the open configuration, where dimensions are provided (in inches) only as one example of an embodiment of the present invention. In FIG. 12, a rear expansion section 300 is shown supported by support arm 301 that may be deployed from arm deployment structure 301A. FIG. 13 shows a top view of the RV 100 of FIG. 1, in the closed configuration. FIG. 14 shows a cross-sectional schematic top view of the RV 100 of FIG. 1, in the closed configuration, where dimensions are provided (in inches) only as one example of an embodiment of the present invention. FIG. 15 shows a cross-sectional schematic top view of the RV 100 of FIG. 1, in the open configuration, where dimensions are provided (in inches) only as one example of an embodiment of the present invention.

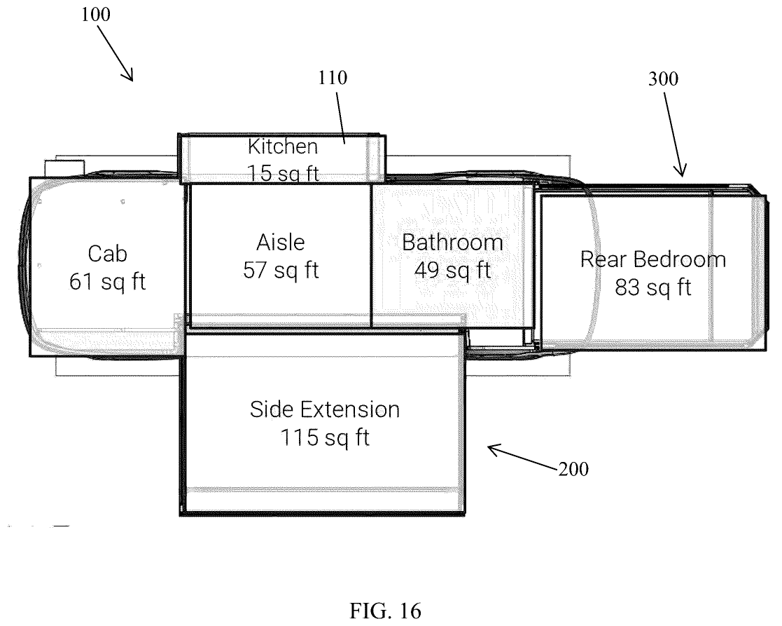

FIG. 16 shows a plan view of an exemplary floor usage/layout of the RV of FIG. 1, in the open configuration, where dimensions (section areas) are provided (in inches) only as one example of an embodiment of the present invention. It should be understood that other room arrangements are within the scope of the present invention. Typically, the living area within the main body would include the aisle and the bathroom, as illustrated in FIG. 16. The living area of the first expansion section is provided as an example. Similarly, the living area of the rear expansion section, labeled “rear bedroom” in FIG. 16, is shown as an example.

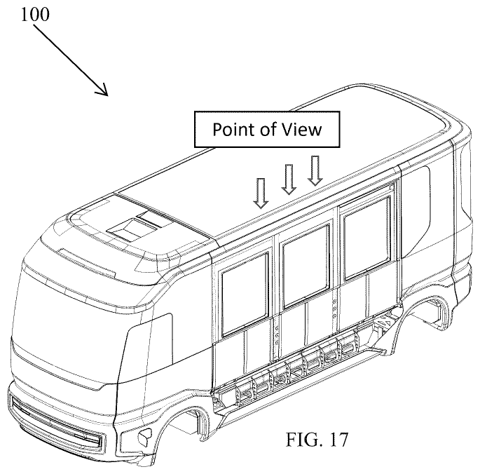

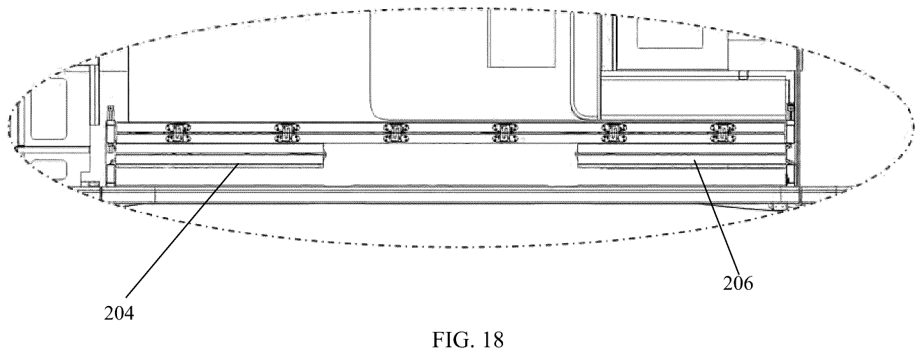

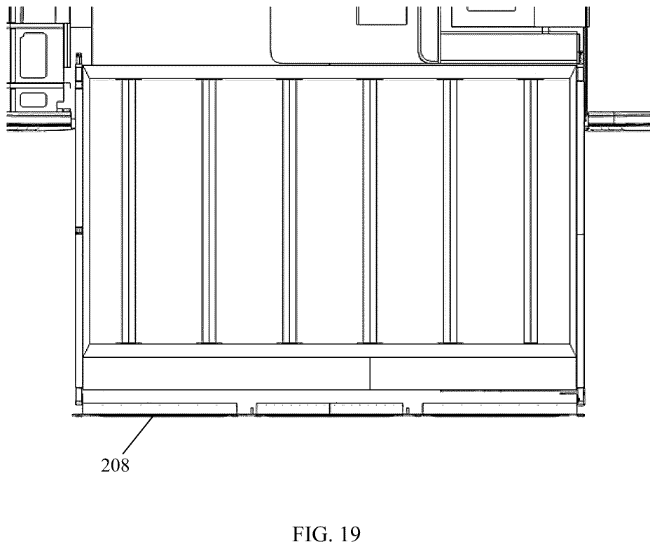

FIG. 17 shows a driver's side perspective view of the RV of FIG. 1, in a closed configuration. FIG. 18 shows a detailed view taken along the arrows of FIG. 17, in the closed configuration, while FIG. 19 shows a detailed view taken along the arrows of FIG. 17, in the open configuration.

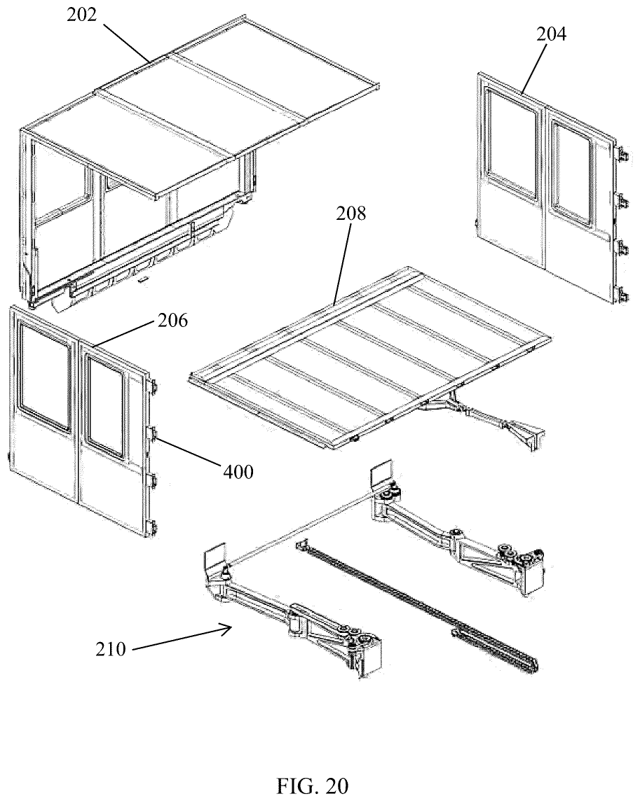

Referring now to FIG. 20, an exploded perspective view of an expansion section 200 of the RV 100 of FIG. 1 is shown. The expansion section 200 includes a side extension outer wall and roof member 202, a side extension bi-fold right-side wall member 204, a side extension bi-fold left-side wall member 206, a side extension foldable floor 208 and a rotational arm extension system 210.

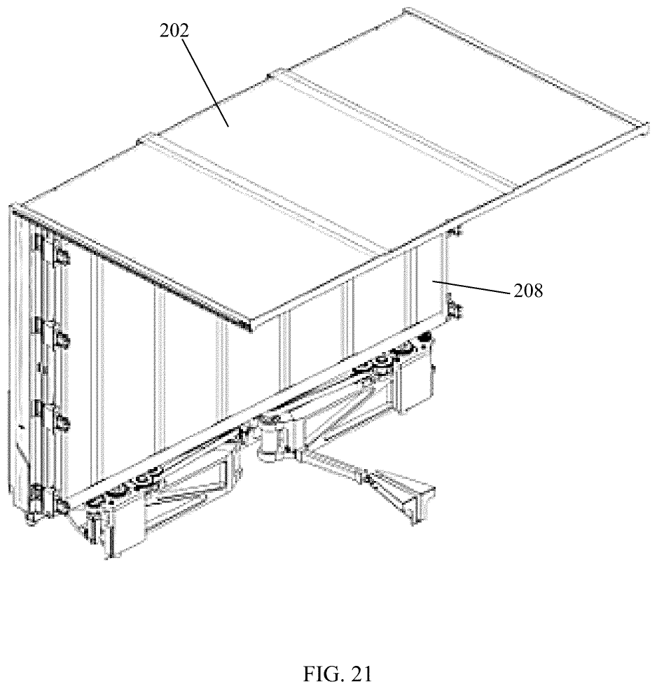

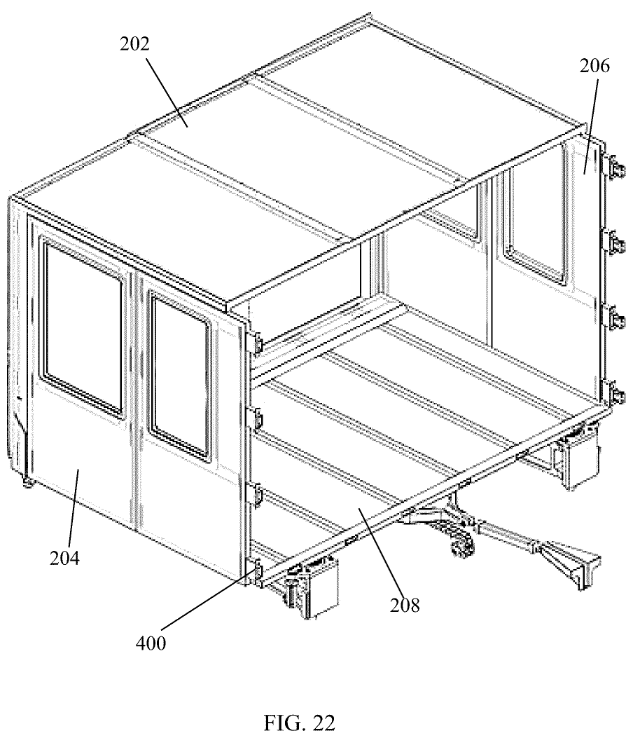

FIG. 21 shows a perspective view of the expansion section 200, in the closed configuration, while FIG. 22 shows a perspective view of the expansion section 200, in the open configuration.

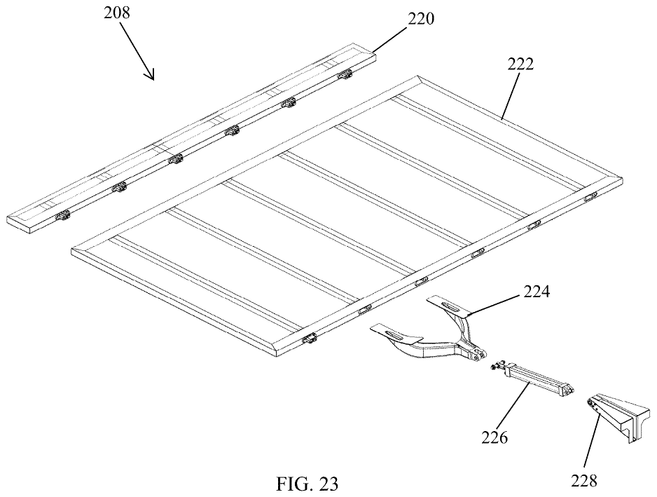

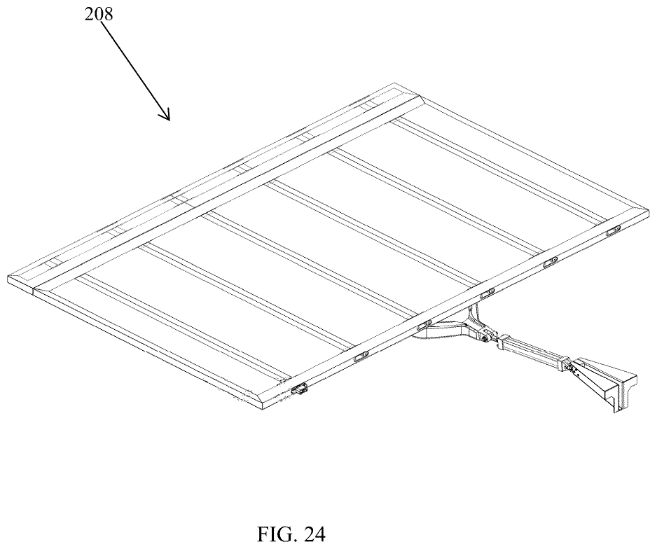

Referring to FIGS. 23 and 24, the foldable floor 208 of the side extension 200 is a component of the overall side extension system. To achieve the desired extension length, a unique bi-fold floor system that integrates seamlessly with the bi-fold wall members 204, 206 and extension arm mechanisms (as described below). The floor 208 includes two primary components: the flooring structure and the hydraulic system. The flooring structure includes a main floor 222 and a secondary floor 220, which are connected by a custom-designed hinge, such as an active hinge 400 (described in greater detail below), to ensure smooth operation and durability. The hydraulic system includes a side floor extension yoke 224, a hydraulic cylinder 226, and mounting hardware 228, all working together to facilitate efficient and reliable floor extension.

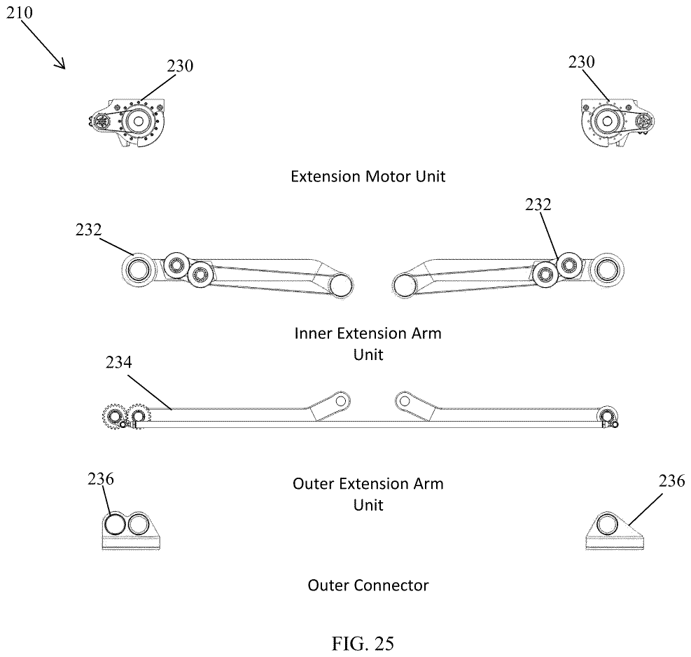

Referring to FIG. 25, the rotational arm extension system 210 is divided into four subassemblies: an extension motor unit 230, an inner extension arm unit 232, an outer extension arm unit 234, and the outer connector 236. The motor unit 230 drives the rotation of the inner extension arm 232, to which it is directly connected. The inner and outer extension arms 232, 234 are joined via center pins, allowing the rotation of the inner extension arm 232 to simultaneously drive the rotation of the outer extension arm 234. The outer connector 236 secures both the living room's outer wall and the outer extension arm unit 234.

To facilitate smooth operation, sets of rotation-assist gears are mounted on the inner extension arm to support the rotation of the center pin. Additionally, the crosslink system ensures the outer extension arm unit maintains a consistent rotational angle throughout its movement.

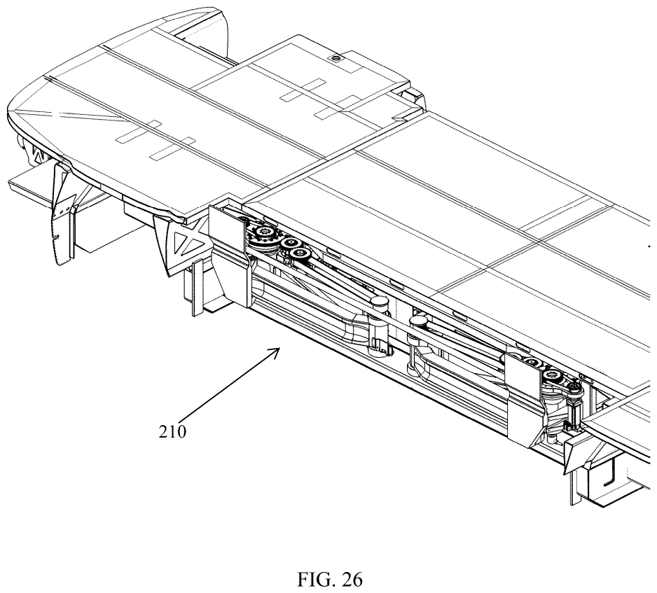

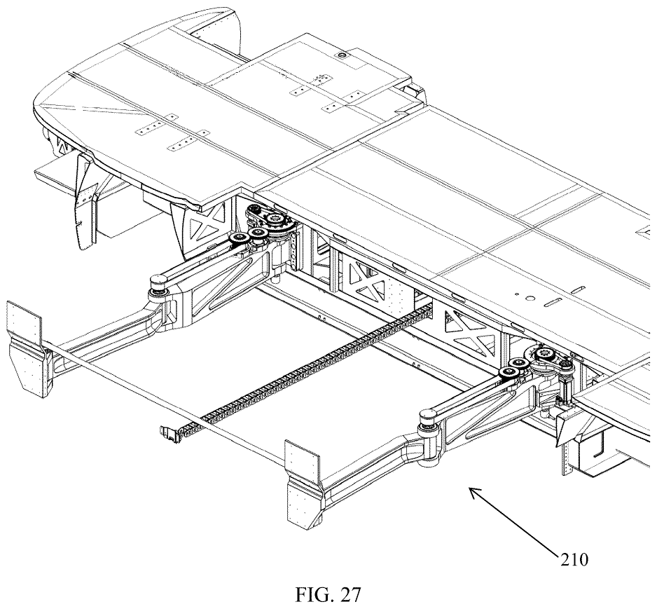

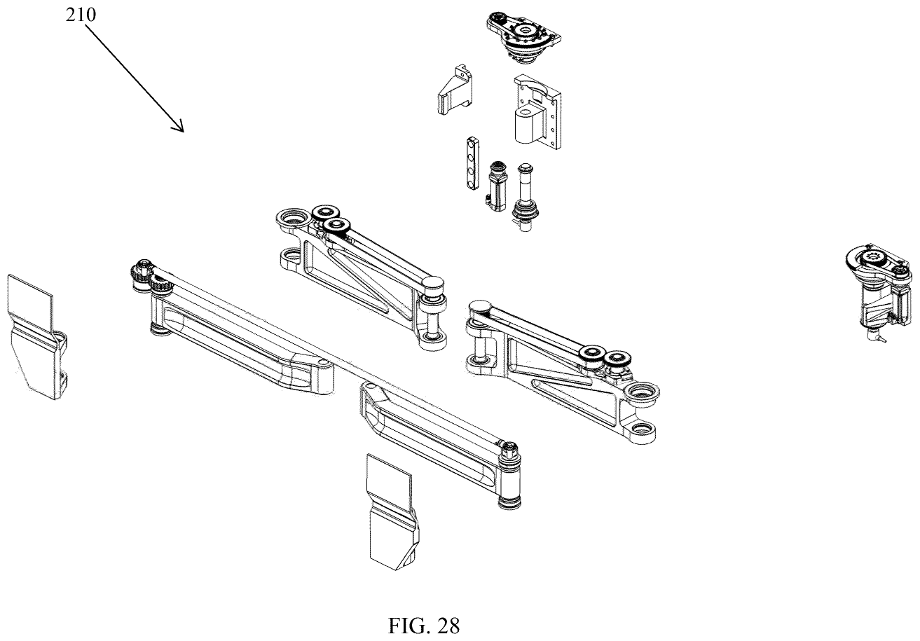

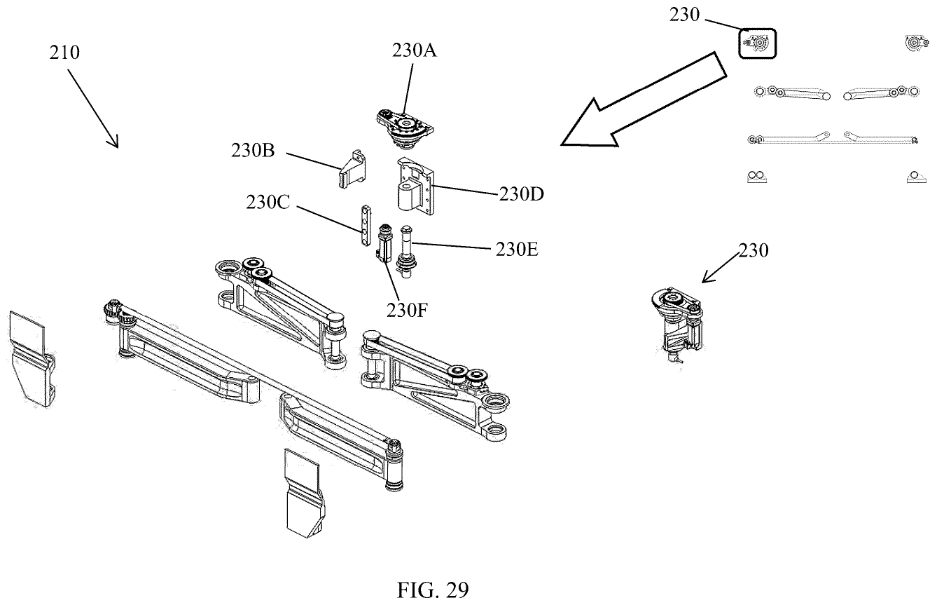

FIG. 26 shows the extension arms 232, 234 of the system 210, in a retracted (closed) configuration, while FIG. 27 shows the extension arms 232, 234 of the system 210, in an expanded (open) configuration. FIG. 28 shows an exploded perspective view of the components of the rotational arm extension system 200, while FIG. 29 shows an exploded perspective view of the components of the rotational arm extension system 200, focusing on the extension motor unit 230. The extension motor unit 230 can include a gearset 230A, an extension arm stopper 230B for the expanded state, an extension arm stopper 230C for the retracted state, a motor unit housing 230D, a main shaft 230E and an outer extension arm 230F. One extension motor unit 230 may be on each side of the expansion section 200.

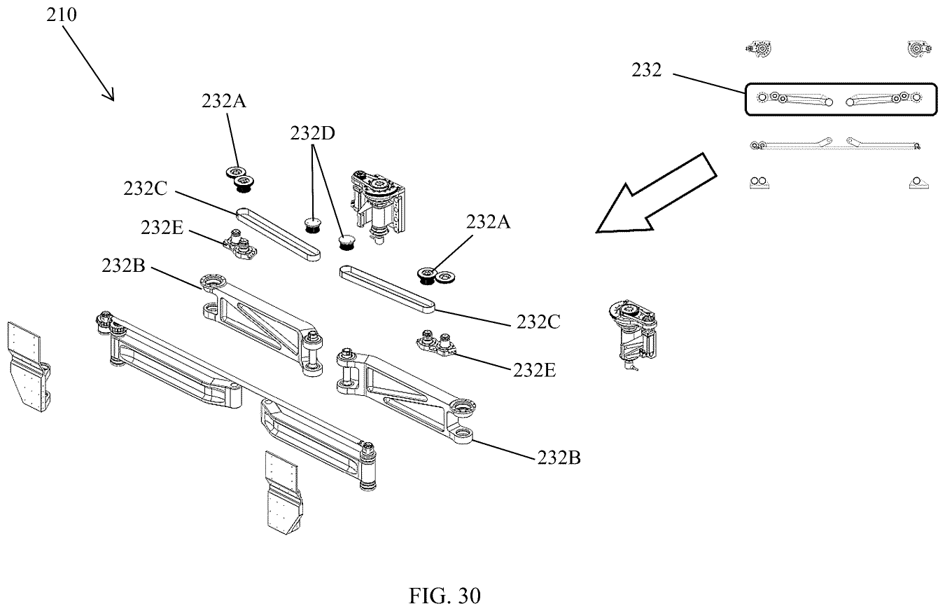

FIG. 30 shows an exploded perspective view of the components of the rotational arm extension system 210, focusing on the inner extension arm unit 232. The inner extension arm unit 232 can include a rotation assist gear set 232A, mounted in a rotation assist gear mount 232E, that can be driven by the extension motor unit 230. The rotation assist gear set 232A can drive the inner extension arm 232B and a belt 232C, which can drive center connection pin gear set 232D.

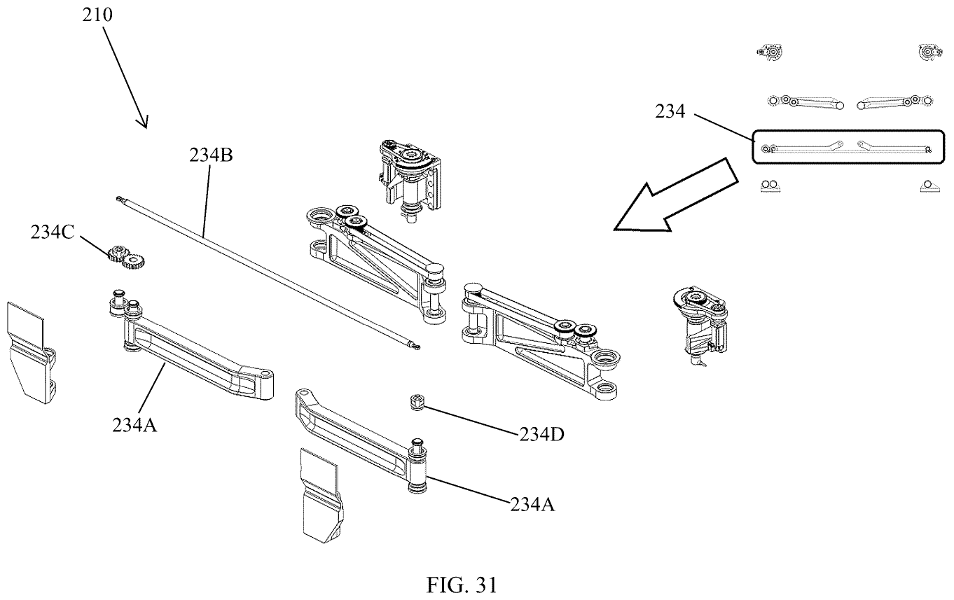

FIG. 31 shows an exploded perspective view of the components of the rotational arm extension system 200, focusing on the outer extension arm unit 234. The outer extension arm unit 234 includes outer extension arms 234A that can be driven by a combination of the crosslink 234B being rotated via right and left crosslink connectors 234C, 234D, and by the rotation of the center connection pin gearset 232D (see FIG. 30) of the inner extension arm unit 232.

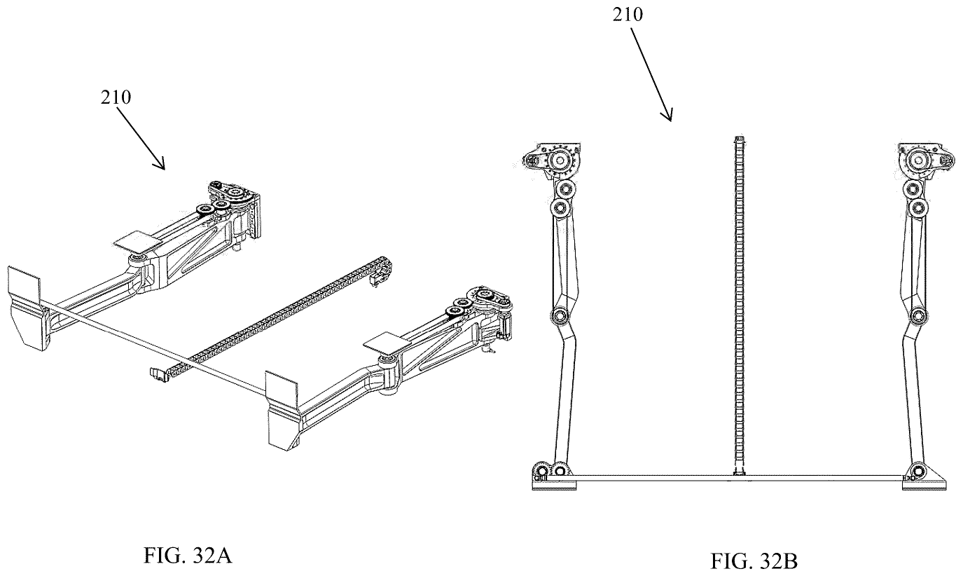

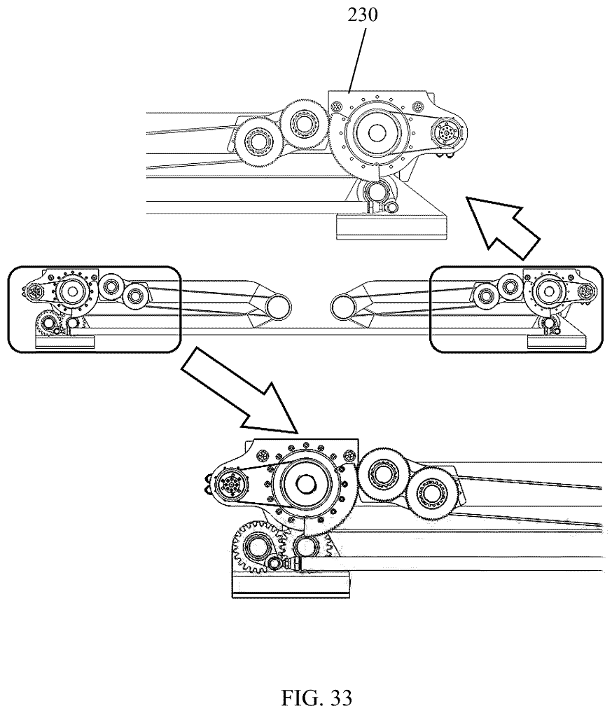

FIGS. 32A and 32B shows a perspective and top views of the rotational arm extension system 210 in the expanded (open) configuration, while FIG. 33 shows a perspective, top and detailed top views of the rotational arm extension system 210, in the retracted (closed) configuration.

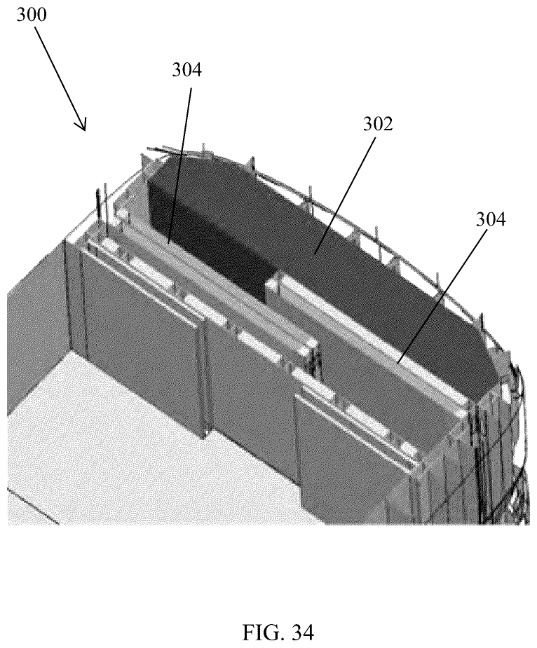

FIG. 34 shows a top perspective cross-sectional schematic view of the rear expansion section 300 of the RV 100 of FIG. 1, in the closed configuration. Bi-fold side walls 304 may be folded together as shown in the closed configuration. A murphy bed 302 may be folded against the rear wall while in the closed configuration.

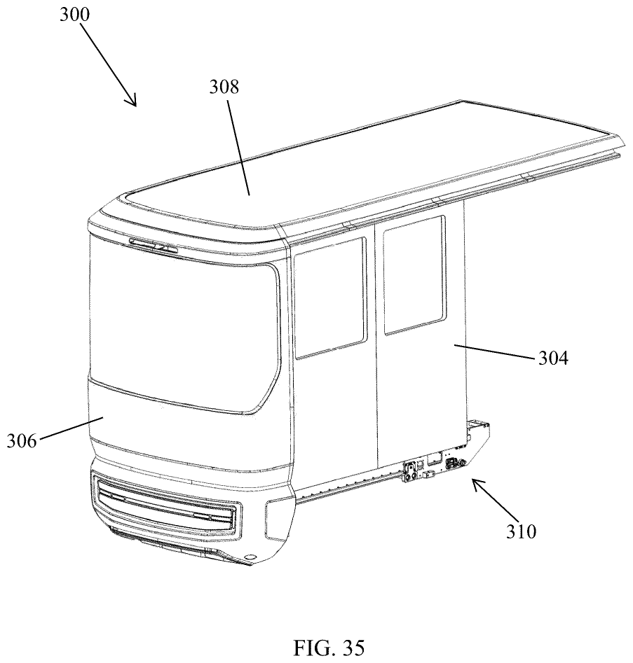

FIG. 35 illustrates a side perspective view of the rear expansion section 300, in the open configuration, showing the bi-fold side walls 304, the rear wall 306, the roof 308 and the I-beam expand system 310.

The rear section of the RV incorporates several components, including the frame, upper slider, bi-folding wall, floor, integrated rear jack, and extend actuator. These components are designed to function harmoniously, ensuring the rear section extends smoothly while maintaining a sleek, clean appearance when retracted.

The frame serves as the structural backbone, providing robust support for the slide-out system during operation and travel. The upper slider (roof 308) facilitates precise and stable movement of the slide-out, ensuring a seamless extension and retraction process. The bi-fold side wall 304 efficiently expands to provide additional interior space while folding compactly to maintain the RV's streamlined exterior design. The floor extends to create a durable and level surface, enhancing usability and comfort for occupants. The integrated rear jack 312 adds stability to the extended rear section, ensuring the RV remains level and secure during use. The extend actuator 310 powers the extension and retraction mechanism, delivering reliable and controlled motion while minimizing noise and energy consumption.

This sophisticated integration of components not only maximizes the functionality and comfort of the rear slide-out but also enhances the RV's aesthetic appeal and structural reliability. It exemplifies innovative engineering tailored for modern RV living.

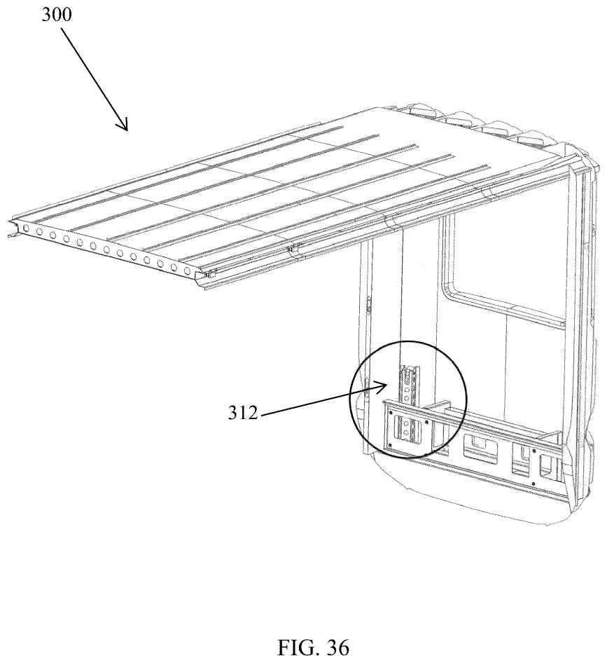

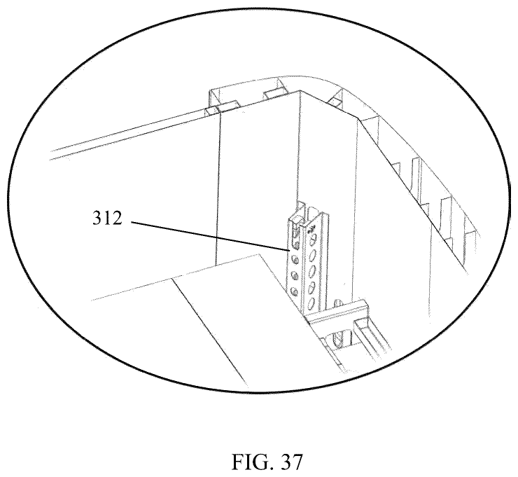

FIG. 36 shows a partial perspective view of the rear expansion section 300, focusing on a jack member 312. FIG. 37 shows a detailed view of the jack member 312. The integrated rear jack member 312 is a component of the slide-out system. When retracted, it seamlessly folds into the frame, remaining completely concealed to maintain the RV's clean and streamlined exterior design. Upon extension, the jack member 312 deploys automatically to provide robust support and ensure the stability of the rear section. This mechanism enhances both the safety and usability of the slide-out, delivering reliable performance without compromising the RV's aesthetics.

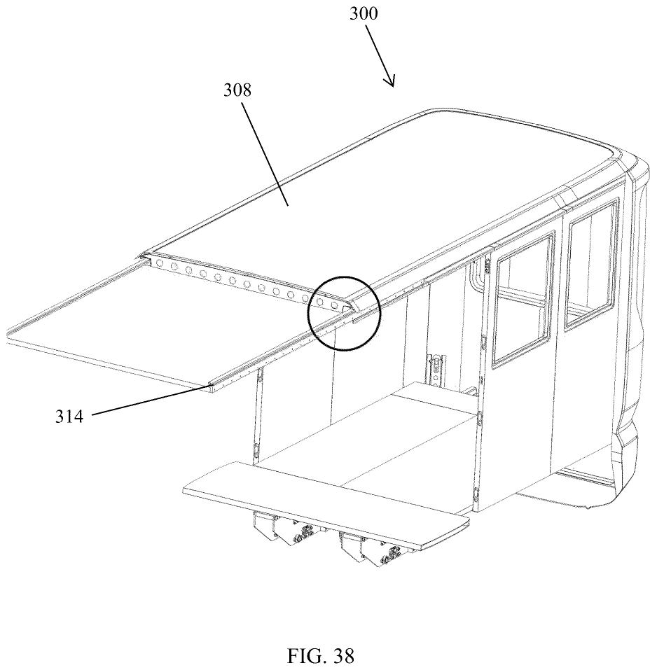

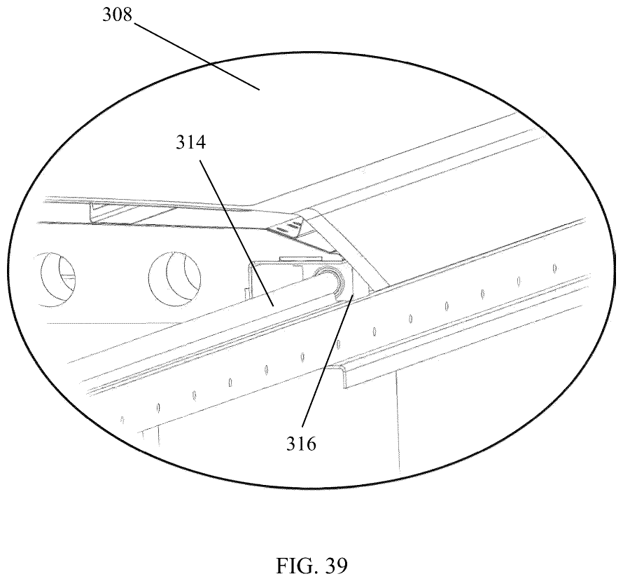

FIG. 38 shows a partial perspective view of the rear expansion section 300, focusing on the upper slider 308 (also referred to as roof 308). FIG. 39 shows a detailed view of the roof 308.

The roof of the center section is designed to house a fixed rail system 314, which serves as the guiding mechanism for the sliding component (roof 308). The slider moves smoothly along this fixed rail 314, ensuring precise alignment and stability during both extension and retraction. This design not only enhances the durability and reliability of the system but also ensures efficient operation, minimizing wear and maintenance over time.

The upper slider is equipped with a linear bearing mechanism 316 that is securely attached to the rear section frame. This system allows the slider to glide smoothly along the fixed rail, ensuring precise and stable movement. The linear bearings minimize friction, enhance durability, and provide consistent performance, even under varying load conditions. This design ensures reliable operation, contributing to the overall functionality and longevity of the slide-out system.

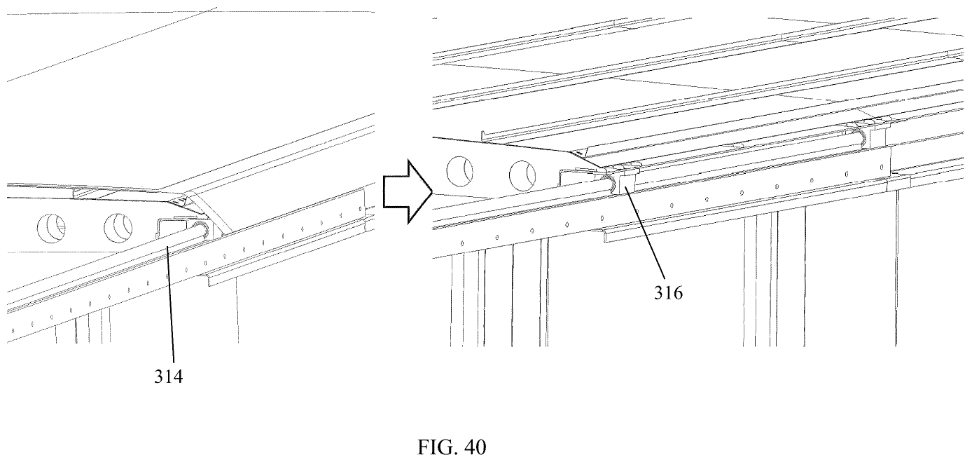

FIG. 40 shows a perspective view of the upper slider 308 with the cover off.

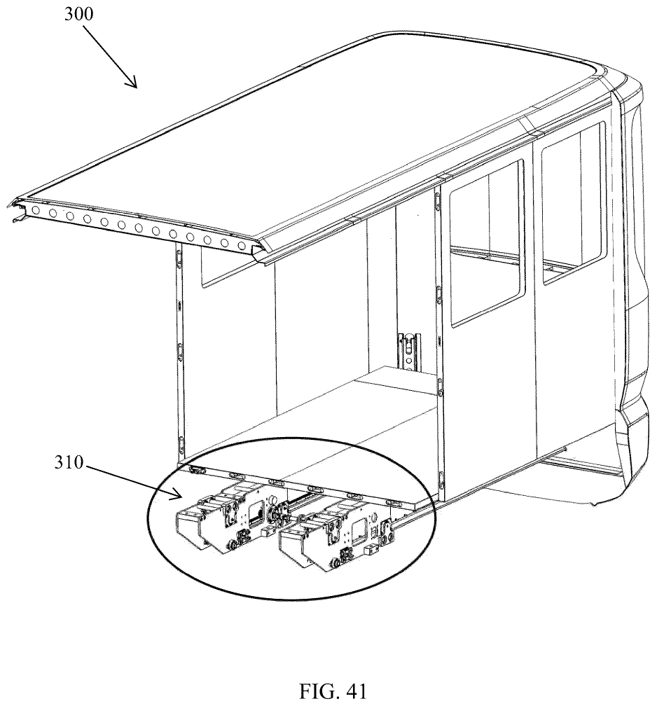

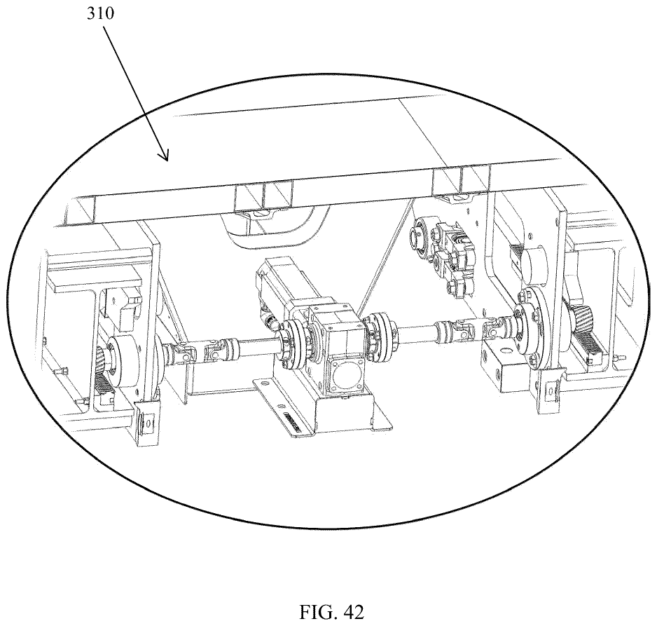

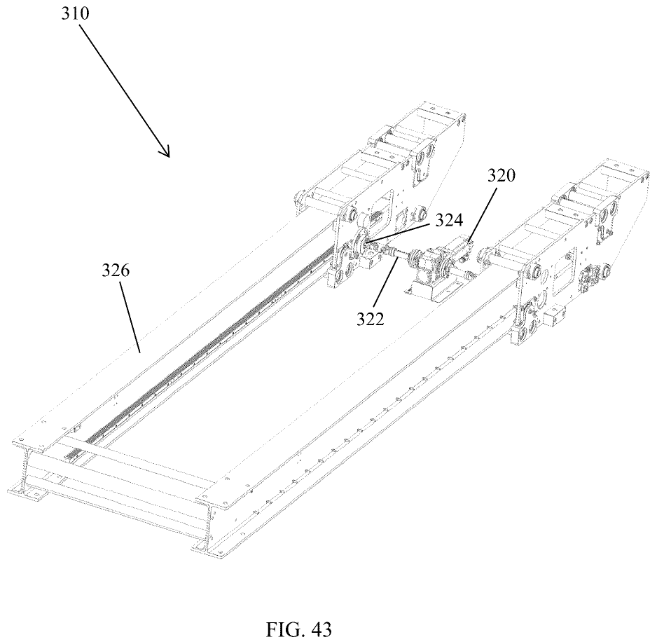

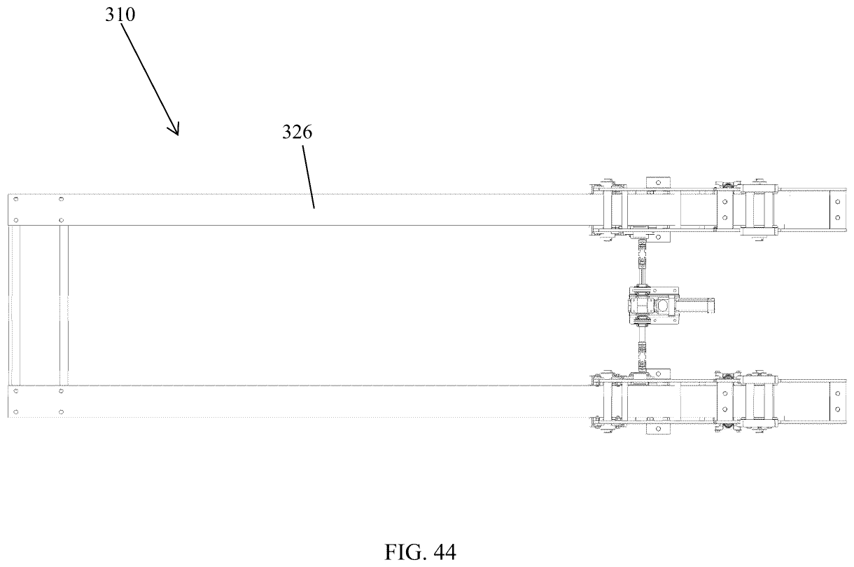

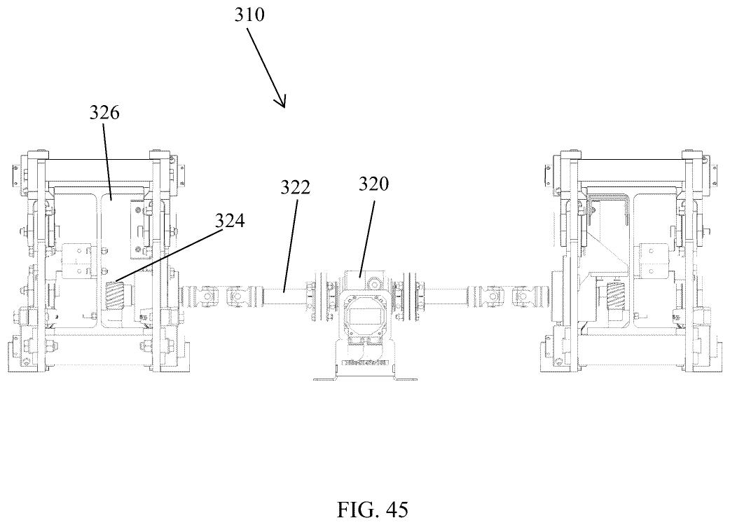

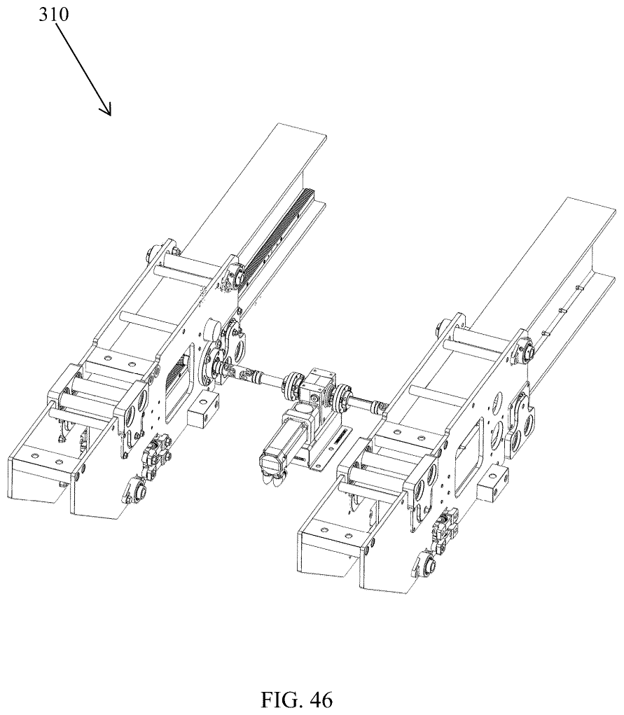

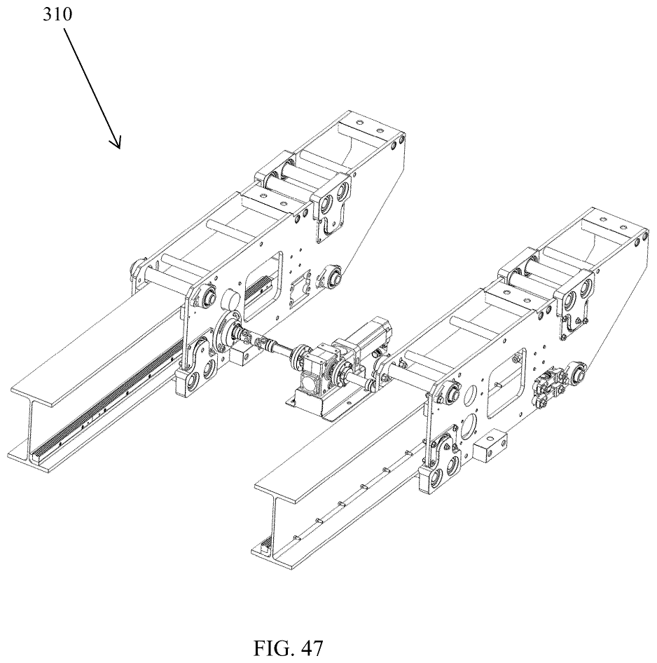

FIG. 41 shows a partial perspective view of the rear expansion section 300, focusing on the I-beam extend mechanism 310 (also referred to as the extension mechanism 310), while FIG. 42 shows a detailed view of the I-beam extend mechanism 310, FIG. 43 shows a perspective view of the I-beam extend mechanism 310, FIG. 44 shows a top view of the I-beam extend mechanism 310, FIG. 45 shows a front view of the I-beam extend mechanism 310, FIG. 46 shows a front perspective view of the I-beam extend mechanism 310, and FIG. 47 shows a rear perspective view of the I-beam extend mechanism 310.

The extension mechanism 310 is powered by a high-torque motor 320, which drives the system with precision and reliability. The motor 320 is connected to a shaft 322 equipped with a pinion gear 324 at its end. This pinion gear 324 engages with a rack attached to an I-beam 326 that supports the entire frame of the rear section.

When the motor 320 rotates, the pinion gear 324 moves along the rack, causing the I-beam 326—and consequently the rear section—to extend smoothly and efficiently. This design ensures stable and controlled motion, while the robust I-beam structure provides ample support for the extended rear section, enhancing durability and functionality.

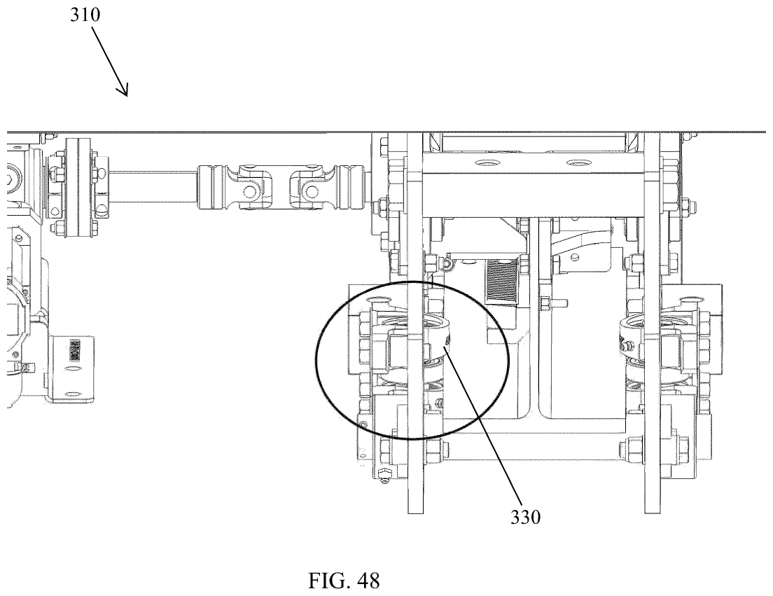

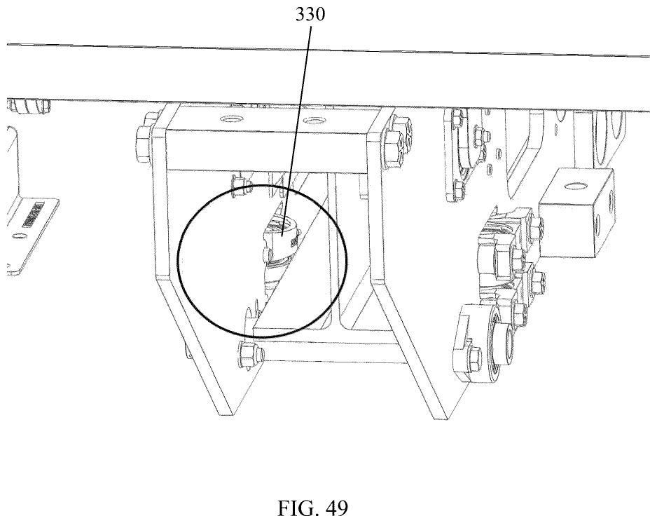

FIG. 48 shows a front view of the I-beam extend mechanism 310, highlighting a roller bearing 330, while FIG. 49 shows a perspective view of the I-beam extend mechanism 310, highlighting the roller bearing 330 therein.

The roller bearing 330 is designed to maintain the horizontal alignment of the I-beam 326, ensuring precise positioning during movement. The roller bearing 330 plays a role in guiding the motion of the I-beam 326, reducing friction and enabling a smooth and controlled extension and retraction process. This design enhances the overall stability and efficiency of the extension mechanism, minimizing wear and ensuring long-term reliability.

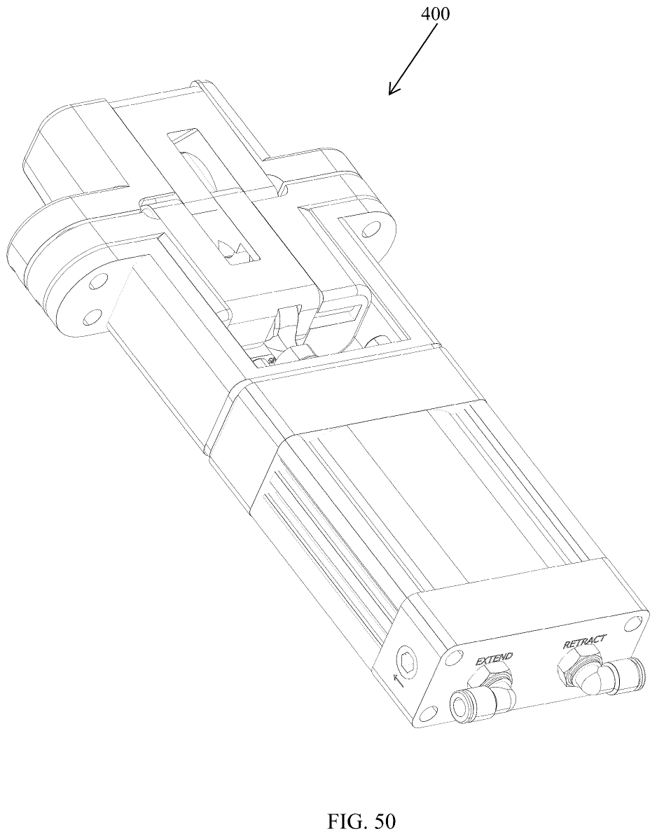

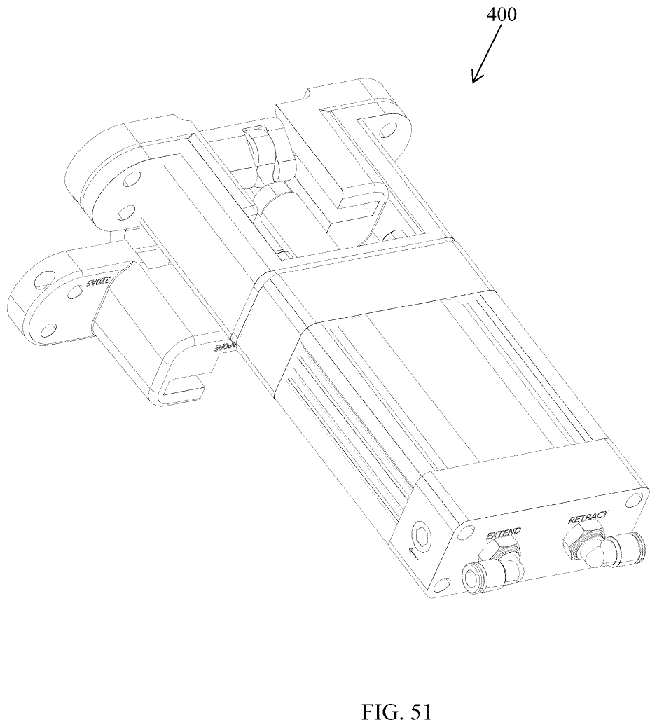

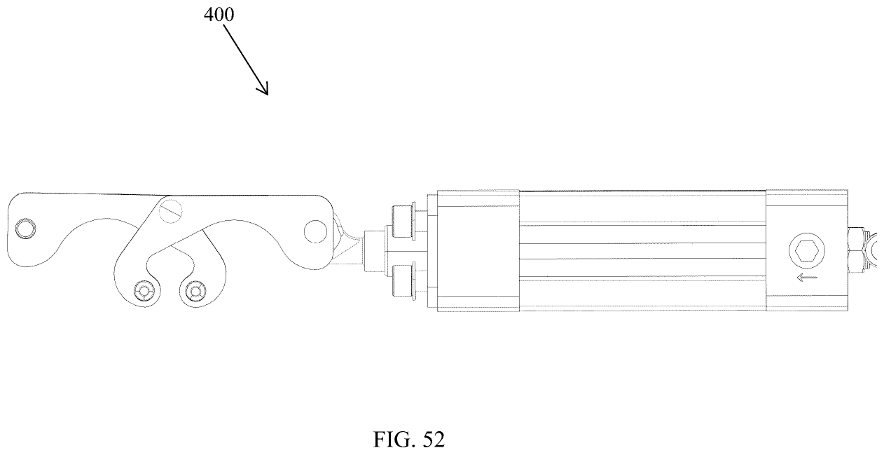

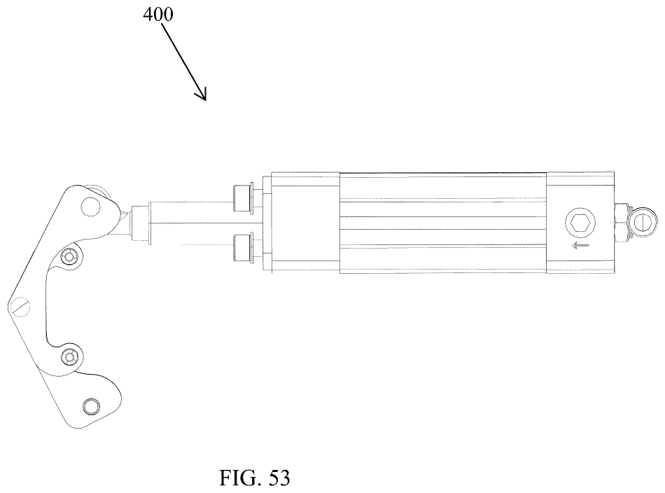

FIG. 50 shows a perspective view of an active hinge 400 used in the RV 100 of FIG. 1, in an opened (extended) state. FIG. 51 shows a perspective view of the active hinge 400, in a closed (folded) state, while FIGS. 52 and 53 show cross-sectional views of the active hinge 400 in the opened and partially closed states, respectively.

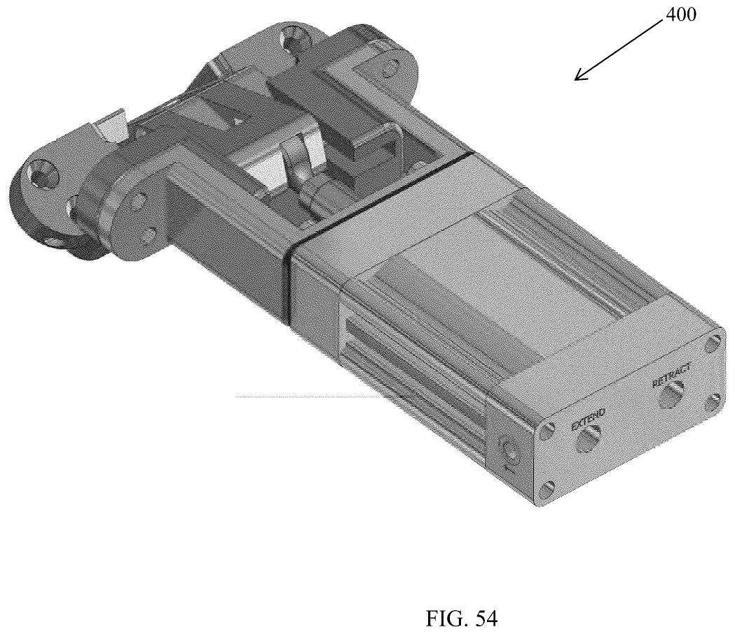

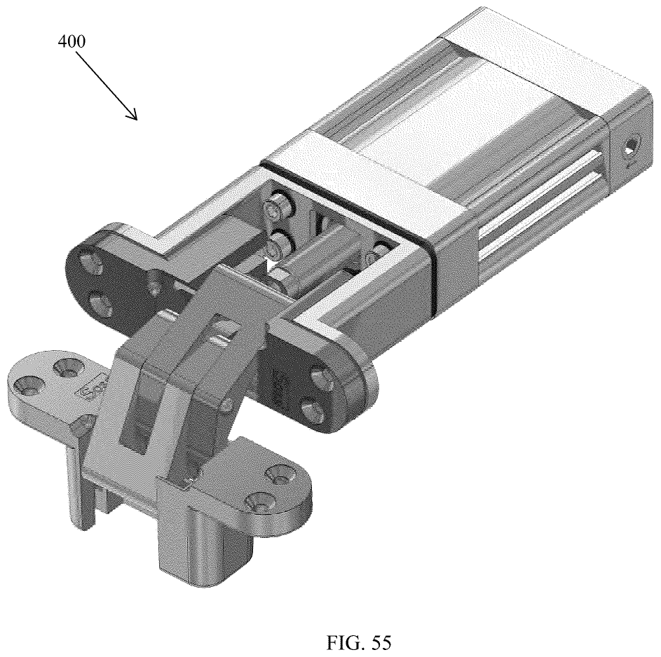

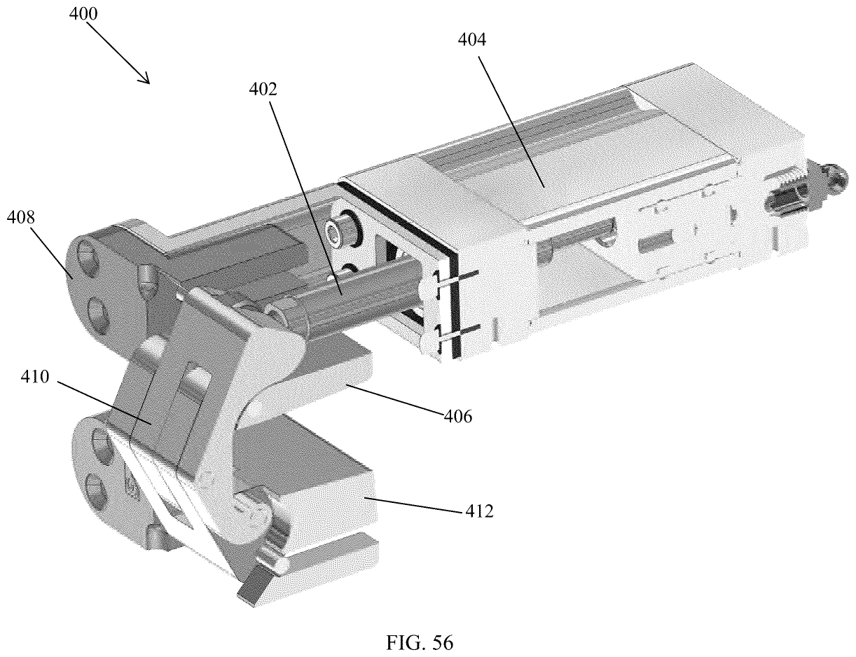

FIG. 54 shows a perspective view of the active hinge 400 beginning a transformation from the opened state toward the closed state, while FIG. 55 shows a perspective view of the active hinge 400, at a half-way position between the opened and closed states, and FIG. 56 shows a perspective view of the active hinge 400 in a completely closed state.

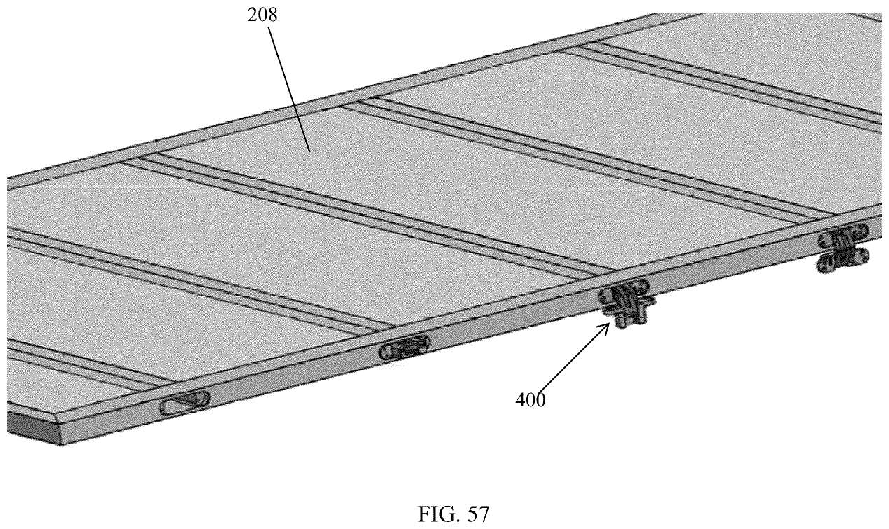

FIG. 57 shows a perspective view of a floor member 208 where the active hinges 400 are disposed. The active hinges 400 may also be attached to the wall members to permit the folding thereof.

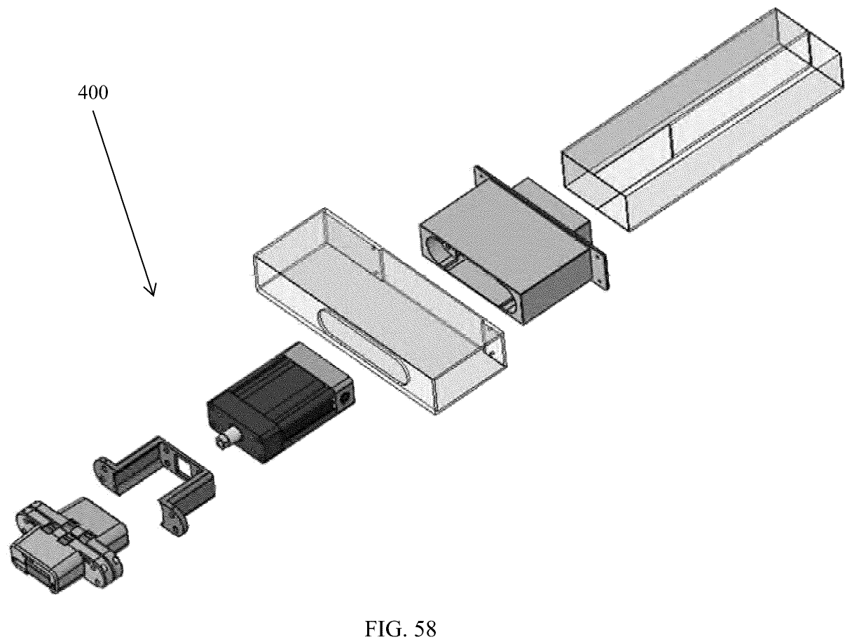

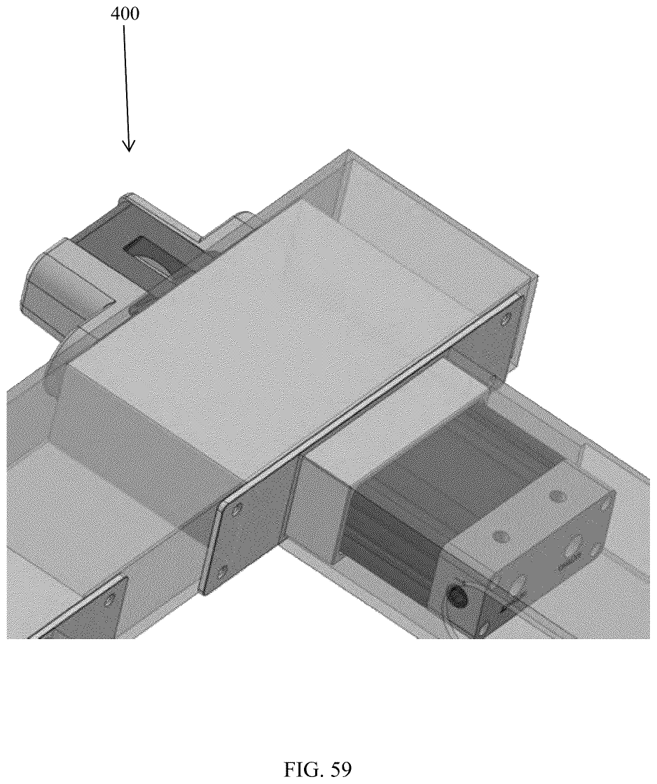

FIG. 58 shows an exploded perspective view of the active hinge 400, while FIG. 59 shows the active hinge 400 in an assembled configuration. The active hinge 400 can include a hydraulic arm 402 driven by a hydraulic driving device 404. The hydraulic arm 402 can attach to an angular motion device 410, that can move about a fixed member 406. The angular motion device 410 can include a first angular motion device 410A and a second angular motion device 410B disposed adjacent each other. The first angular motion device 410A may travel along and pivot with respect to a slot 414 formed in the fixed bracket 408. The second angular motion device 410B can pivot relative to the first angular motion device 410A. A moved wall member (not shown) can be attached to movable bracket 412, which is attached to the angular motion device 410. The movable bracket 412 can move about a 180-degree angle in a short distance, permit bi-folding of door and wall members. A fixed wall member (not shown) can be attached to fixed bracket 408. Thus, when folded, the wall members may be disposed adjacent one another, but, when extended, the wall members may form a solid wall section.

While the above described a mobile living unit, such as RV 100, having multiple features of the present invention incorporated therein, it should be understood that each aspect of the present invention, as disclosed herein, may be used separately or in combination with any other one or more features disclosed herein. Accordingly, it should be understood that each component may be separately used in various environments or may be used in combination with other aspects of the invention in one or more environments, including in mobile living units.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. An active hinge for hingedly connecting a first member with a second member, comprising:
a fixed bracket attached to the first member, wherein the first member is fixed relative to a structure;
a movable bracket attached to the second member, wherein the second member is movable relative to the first member;
a movable arm driven by a driving device;
an angular motion device attached to the movable arm; and
a fixed member having an outer surface upon which the angular motion device travels during movement of the movable arm, wherein:
when the movable arm is extended, the angular motion device moves to move the movable bracket into a retracted position, where the first member is disposed adjacent the second member; and
when the movable arm is retracted, the angular motion device moves to move the movable bracket into an extended position, where the first member is disposed adjacent the second member to form a continuous surface.

2. The active hinge of claim 1, wherein the driving device is a hydraulic driving device.

3. The active hinge of claim 2, wherein the hydraulic driving device has a first hydraulic connection for actively extending the movable arm and a second hydraulic connection for actively retracting the movable arm.

4. The active hinge of claim 1, wherein the angular motion device includes a first angular motion device disposed adjacent to and offset from a second angular motion device, wherein the first and second angular motion devices permit rotation of the hinge about an angle of 180 degrees.

5. The active hinge of claim 4, wherein the first angular motion device slides along a slot formed in the fixed bracket.

6. The active hinge of claim 1, wherein the first member is a first wall panel of an expansion section of a recreational vehicle and the second member is a second wall panel of the expansion section of the recreational vehicle.

7. The active hinge of claim 6, wherein the first wall panel is stored adjacent the second wall panel when the movable arm is extended.

8. The active hinge of claim 6, wherein retraction of the movable arm moves the first wall panel alongside the second wall panel to form a continuous wall surface, while assisting in the expansion of the expansion section of the recreational vehicle.

9. The active hinge of claim 1, wherein the first member is a primary floor panel, and the second member is a secondary floor panel.

10. The active hinge of claim 9, wherein the primary floor panel is stored adjacent the secondary floor panel when the movable arm is extended.

11. The active hinge of claim 9, wherein retraction of the movable arm moves the secondary floor panel alongside the primary floor panel to form a continuous floor surface, while assisting in the expansion of the expansion section of the recreational vehicle.

12. An active hinge for hingedly connecting a first member with a second member, comprising:
a fixed bracket attached to the first member, wherein the first member is fixed relative to a structure;
a movable bracket attached to the second member, wherein the second member is movable relative to the first member;
a movable arm driven by a hydraulic driving device, wherein a force applied by the hydraulic driving device includes a first force to move the movable arm in a first direction and a second force to move the movable arm in a second direction opposite the first direction;
an angular motion device attached to the movable arm; and
a fixed member having an outer surface upon which the angular motion device travels during movement of the movable arm, wherein:
when the movable arm is extended, the angular motion device moves to move the movable bracket into a retracted position, where the first member is disposed adjacent the second member; and
when the movable arm is retracted, the angular motion device moves to move the movable bracket into an extended position, where the first member is disposed adjacent the second member to form a continuous surface.

13. The active hinge of claim 12, wherein the angular motion device includes a first angular motion device disposed adjacent to and offset from a second angular motion device, wherein the first and second angular motion devices permit rotation of the hinge about an angle of 180 degrees.

14. The active hinge of claim 13, wherein the first angular motion device slides along a slot formed in the fixed bracket.

15. A recreational vehicle having at least one expansion section utilizing an active hinge for expansion and retraction thereof, the active hinge comprising:
a fixed bracket attached to the first member, wherein the first member is fixed relative to a structure;
a movable bracket attached to the second member, wherein the second member is movable relative to the first member;
a movable arm driven by a driving device;
an angular motion device attached to the movable arm; and
a fixed member having an outer surface upon which the angular motion device travels during movement of the movable arm, wherein:
when the movable arm is extended, the angular motion device moves to move the movable bracket into a retracted position, where the first member is disposed adjacent the second member; and
when the movable arm is retracted, the angular motion device moves to move the movable bracket into an extended position, where the first member is disposed adjacent the second member to form a continuous surface.

16. The recreational vehicle of claim 15, wherein:
the angular motion device includes a first angular motion device disposed adjacent to and offset from a second angular motion device, wherein the first and second angular motion devices permit rotation of the hinge about an angle of 180 degrees; and
the first angular motion device slides along a slot formed in the fixed bracket.

17. The recreational vehicle of claim 15, wherein:
the first member is a first wall panel of an expansion section of a recreational vehicle and the second member is a second wall panel of the expansion section of the recreational vehicle; and
the first wall panel is stored adjacent the second wall panel when the movable arm is extended.

18. The recreational vehicle of claim 17, wherein retraction of the movable arm moves the first wall panel alongside the second wall panel to form a continuous wall surface, while assisting in the expansion of the expansion section of the recreational vehicle.

19. The recreational vehicle of claim 15, wherein:
the first member is a primary floor panel, and the second member is a secondary floor panel; and
the primary floor panel is stored adjacent the secondary floor panel when the movable arm is extended.

20. The recreational vehicle of claim 19, wherein retraction of the movable arm moves the secondary floor panel alongside the primary floor panel to form a continuous floor surface, while assisting in the expansion of the expansion section of the recreational vehicle.
